(19) United States
(12) Patent Application Publication
(10) Pub. No.: US 2024/0334522 A1
(43) Pub. Date: Oct. 3, 2024

(54) BEAM FAILURE RECOVERY IN SIDELINK

(71) Applicant: Samsung Electronics Co., Ltd., Suwon-si (KR)

(72) Inventors: Emad Nader Farag, Flanders, NJ (US); Eko Onggosanusi, Coppell, TX (US); Dalin Zhu, Allen, TX (US)

(21) Appl. No.: 18/610,121

(22) Filed: Mar. 19, 2024

Related U.S. Application Data
(60) Provisional application No. 63/456,702, filed on Apr. 3, 2023.
(60) Provisional application No. 63/465,464, filed on May 10, 2023.

(51) Int. Cl. H04W 76/19; H04W 24/08; H04W 72/40

(52) U.S. Cl. CPC H04W 76/19; H04W 24/08; H04W 72/40

(57) ABSTRACT

Methods and apparatuses for beam failure recovery in sidelink (SL). A method of operating a user equipment (UE) includes receiving, from a second UE a first instance of a first SL channel and M SL signals for identification of new beams, where M>1 and measuring a metric based on the first SL channel. The method further includes declaring, based on the metric, a beam failure; identifying, based on the declaration of the beam failure, a SL signal from the M SL signals for identification of a new beam; and transmitting a second SL channel with a first beam indication based on the SL signal.

### CROSS-REFERENCE TO RELATED AND CLAIM OF PRIORITY

The present application claims priority under 35 U.S.C. § 119 (e) to U.S. Provisional Patent Application No. 63/456,702 filed on Apr. 3, 2023, and U.S. Provisional Patent Application No. 63/465,464 filed on May 10, 2023, which are hereby incorporated by reference in their entirety.

### TECHNICAL FIELD

The present disclosure relates generally to wireless communication systems and, more specifically, the present disclosure relates to method and apparatuses for beam failure recovery in sidelink (SL).

### BACKGROUND

Wireless communication has been one of the most successful innovations in modern history. Recently, the number of subscribers to wireless communication services exceeded five billion and continues to grow quickly. The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage is of paramount importance. To meet the demand for wireless data traffic having increased since deployment of 4G communication systems, and to enable various vertical applications, 5G communication systems have been developed and are currently being deployed.

### SUMMARY

The present disclosure relates to beam failure recovery in SL.

In one embodiment, a user equipment (UE) is provided. The UE includes a transceiver configured to receive, from a second UE a first instance of a first sidelink (SL) channel and M SL signals for identification of new beams, where M>1. The UE further includes a processor operably coupled to the transceiver. The processor is configured to measure a metric based on the first SL channel, declare, based on the metric, a beam failure, and identify, based on the declaration of the beam failure, a SL signal from the M SL signals for identification of a new beam. The transceiver is further configured to transmit a second SL channel with a first beam indication based on the SL signal.

In another embodiment, a method of operating a UE is provided. The method includes receiving, from a second UE a first instance of a first SL channel and M SL signals for identification of new beams, where M>1 and measuring a metric based on the first SL channel. The method further includes declaring, based on the metric, a beam failure; identifying, based on the declaration of the beam failure, a SL signal from the M SL signals for identification of a new beam; and transmitting a second SL channel with a first beam indication based on the SL signal.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example gNodeB (gNB) according to embodiments of the present disclosure;

FIG. 3 illustrates an example user equipment (UE) according to embodiments of the present disclosure;

FIGS. 4A and 4B illustrate an example of a wireless transmit and receive paths according to embodiments of the present disclosure;

FIG. 5A illustrates an example of a wireless system according to embodiments of the present disclosure;

FIG. 5B illustrates an example of a multi-beam operation according to embodiments of the present disclosure;

FIG. 6 illustrates an example of a transmitter structure for beamforming according to embodiments of the present disclosure;

FIG. 7 illustrates a diagram of an example medium access control (MAC) control element (CE) signaling according to embodiments of the present disclosure;

FIG. 8 illustrates a diagram of an example physical sidelink shared channel (PSSCH)/physical sidelink control channel (PSCCH) and physical sidelink feedback channel (PSFCH) transmission according to embodiments of the present disclosure;

FIG. 9 illustrates a diagram of example PSSCH/PSCCH and PSFCH transmissions according to embodiments of the present disclosure;

FIG. 10 illustrates diagrams of example channel state information reference signal (CSI-RS) slots according to embodiments of the present disclosure;

FIG. 11 illustrates diagrams of example CSI-RS slots according to embodiments of the present disclosure;

FIG. 12 illustrates diagrams of example CSI-RS slots according to embodiments of the present disclosure;

FIG. 13 illustrates diagrams of example CSI-RS slots according to embodiments of the present disclosure;

FIG. 14 illustrates a timeline for applying an indicated beam according to embodiments of the present disclosure; and

FIG. 15 illustrates a flowchart of an example UE procedure for beam failure detection and beam failure recovery according to embodiments of the present disclosure.

### DETAILED DESCRIPTION

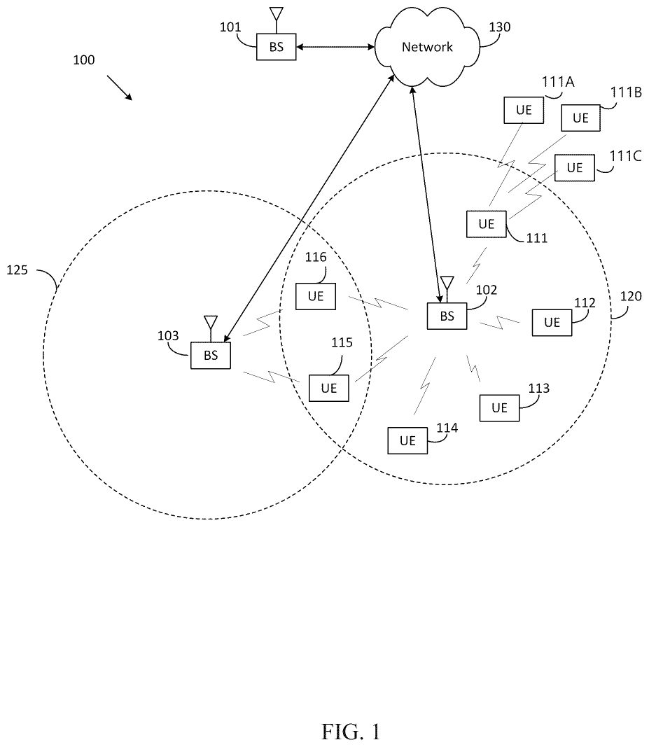

FIGS. 1-15, discussed below, and the various, non-limiting embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

To meet the demand for wireless data traffic having increased since deployment of 4G communication systems, and to enable various vertical applications, 5G/NR communication systems have been developed and are currently being deployed. The 5G/NR communication system is implemented in higher frequency (mm Wave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (COMP), reception-end interference cancelation, radio access technology (RAT)-dependent positioning and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to the deployment of 5G communication systems, 6G, or even later releases which may use terahertz (THz) bands.

The following documents and standards descriptions are hereby incorporated by reference into the present disclosure as if fully set forth herein: [1] 3GPP TS 38.211 v18.1.0, “NR; Physical channels and modulation;” [2] 3GPP TS 38.212 v18.1.0, “NR; Multiplexing and Channel coding;” [3] 3GPP TS 38.213 v18.1.0, “NR; Physical Layer Procedures for Control;” [4] 3GPP TS 38.214 v18.1.0, “NR; Physical Layer Procedures for Data;” [5] 3GPP TS 38.321 v18.0.0, “NR; Medium Access Control (MAC) protocol specification;” [6] 3GPP TS 38.331 v18.0.0, “NR; Radio Resource Control (RRC) Protocol Specification;” [7] 3GPP TS 36.213 v18.1.0, “Evolved Universal Terrestrial Radio Access (E-UTRA); Physical layer procedures;” and [8] RP-213678, “WID on NR sidelink evolution.”

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to how different embodiments may be implemented. Different embodiments of the present disclosure may be implemented in any suitably arranged communications system.

FIG. 1 illustrates an example wireless network 100 according to embodiments of the present disclosure. The embodiment of the wireless network 100 shown in FIG. 1 is for illustration only. Other embodiments of the wireless network 100 could be used without departing from the scope of this disclosure.

As shown in FIG. 1, the wireless network 100 includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

In another example, the UE 116 may be within network coverage and the other UE may be outside network coverage (e.g., UEs 111A-111C). In yet another example, both UEs are outside network coverage. In some embodiments, one or more of the gNBs 101-103 may communicate with each other and with the UEs 111-116 using 5G/NR, LTE, LTE-A, WiMAX, WiFi, or other wireless communication techniques. In some embodiments, the UEs 111-116 may use a device to device (D2D) interface called PC5 (e.g., also known as sidelink at the physical layer) for communication.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

The dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof for utilizing and supporting beam failure recovery in SL.

Although FIG. 1 illustrates one example of a wireless network, various changes may be made to FIG. 1. For example, the wireless network 100 could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

As discussed in greater detail below, the wireless network 100 may have communications facilitated via one or more devices (e.g., UEs 111A to 111C) that may have a SL communication with the UE 111. The UE 111 can communicate directly with the UEs 111A to 111C through a set of SLs (e.g., SL interfaces) to provide sideline communication, for example, in situations where the UEs 111A to 111C are remotely located or otherwise in need of facilitation for network access connections (e.g., BS 102) beyond or in addition to traditional fronthaul and/or backhaul connections/interfaces. In one example, the UE 111 can have direct communication, through the SL communication, with UEs 111A to 111C with or without support by the BS 102. Various of the UEs (e.g., as depicted by UEs 112 to 116) may be capable of one or more communication with their other UEs (such as UEs 111A to 111C as for UE 111).

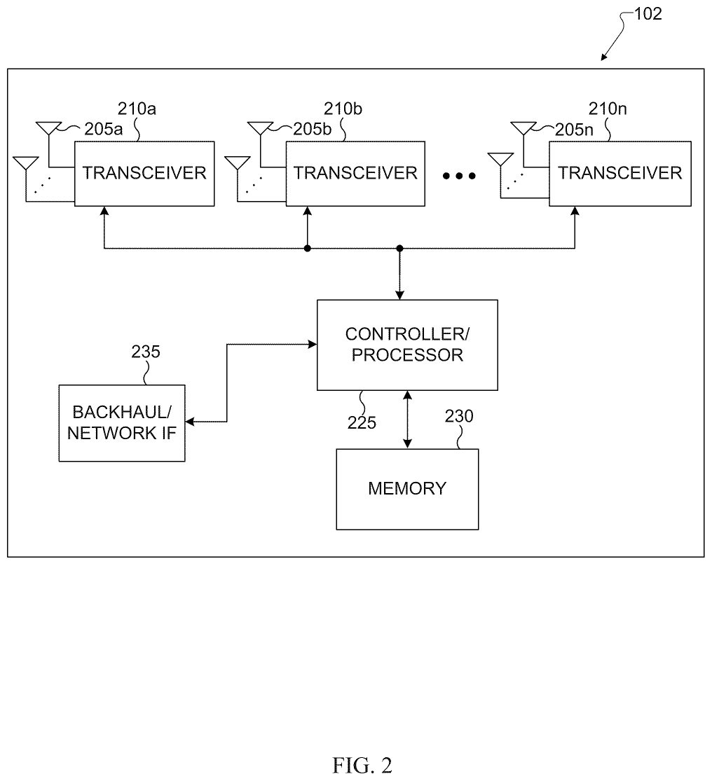

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming radio frequency (RF) signals, such as signals transmitted by UEs in the wireless network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of uplink (UL) channels and/or signals and the transmission of downlink (DL) channels and/or signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the gNB 102 by the controller/processor 225.

The controller/processor 225 is also capable of executing programs and other processes resident in the memory 230, such as to support beam failure recovery in SL. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

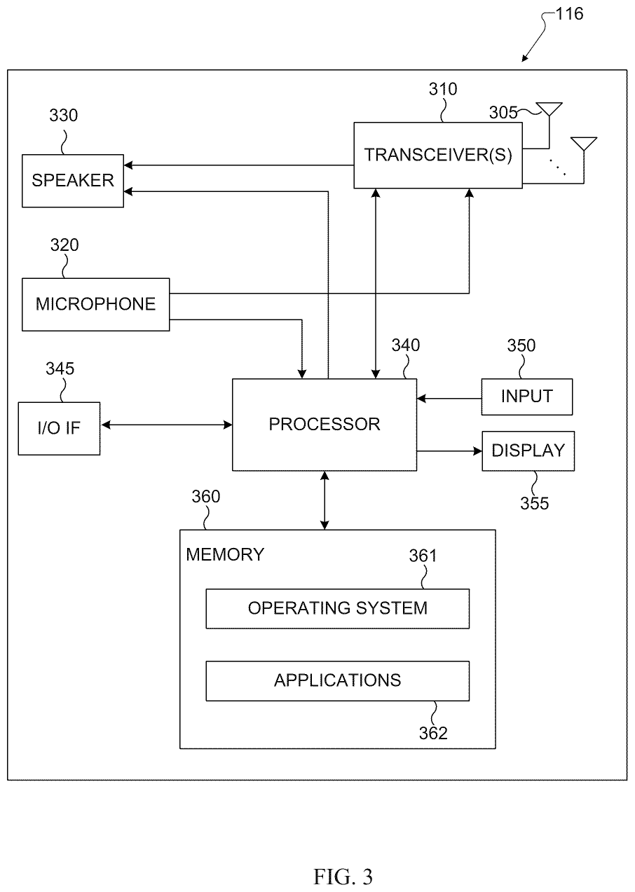

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. Additionally, where the term “UE” is used herein, the UE may be any of UE's 111-116 in FIG. 1 and this UE may have the same or similar configuration as described with and illustrated respect to UE 116 in FIG. 3. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna(s) 305, an incoming RF signal transmitted by a gNB of the wireless network 100 or by other UEs (e.g., one or more of UEs 111-115) on a SL channel. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channels and/or signals or SL channels and/or signals and the transmission of UL channels and/or signals or SL channels and/or signals by the transceiver(s) 310 in accordance with well-known principles. In some embodiments, the processor 340 includes at least one microprocessor or microcontroller.

The processor 340 is also capable of executing other processes and programs resident in the memory 360. For example, the processor 340 may execute processes for utilizing and supporting beam failure recovery in SL as described in embodiments of the present disclosure. The processor 340 can move data into or out of the memory 360 as required by an executing process. In some embodiments, the processor 340 is configured to execute the applications 362 based on the OS 361 or in response to signals received from gNBs or another SL UE or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes, for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

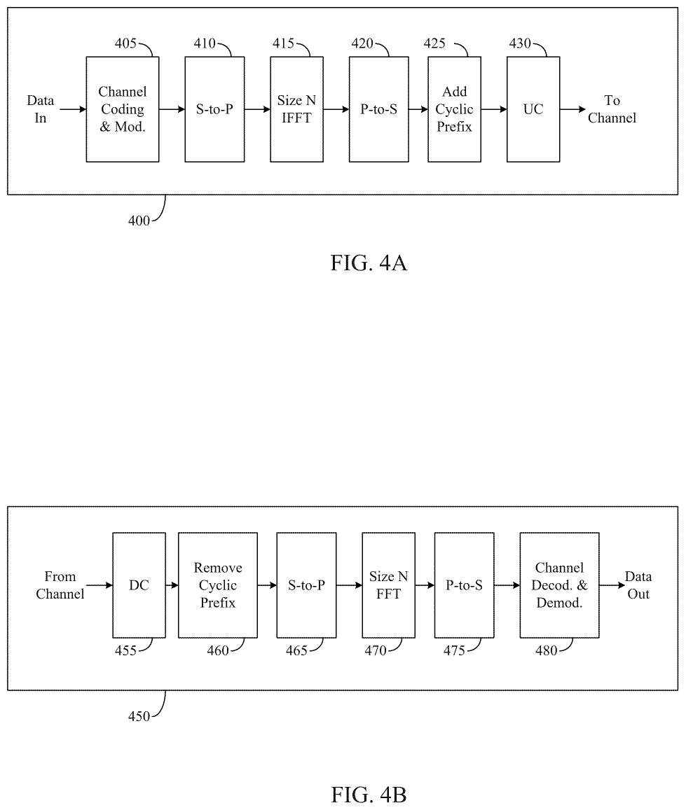

FIG. 4A and FIG. 4B illustrate an example of wireless transmit and receive paths 400 and 450, respectively, according to embodiments of the present disclosure. For example, a transmit path 400 may be described as being implemented in a gNB (such as gNB 102), while a receive path 450 may be described as being implemented in a UE (such as UE 116). However, it will be understood that the receive path 450 can be implemented in a gNB and that the transmit path 400 can be implemented in a UE. It may also be understood that the receive path 450 can be implemented in a first UE and that the transmit path 400 can be implemented in a second UE to support SL communications or SL positioning. In some embodiments, the transmit path 400 and the receive path 450 can be configured to support beam failure recovery in SL as described in embodiments of the present disclosure.

As illustrated in FIG. 4A, the transmit path 400 includes a channel coding and modulation block 205, a serial-to-parallel (S-to-P) block 410, a size N Inverse Fast Fourier Transform (IFFT) block 415, a parallel-to-serial (P-to-S) block 420, an add cyclic prefix block 425, and an up-converter (UC) 430. The receive path 450 includes a down-converter (DC) 455, a remove cyclic prefix block 460, a S-to-P block 465, a size N Fast Fourier Transform (FFT) block 470, a parallel-to-serial (P-to-S) block 475, and a channel decoding and demodulation block 480.

In the transmit path 400, the channel coding and modulation block 405 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 410 converts (such as de-multiplexes) the serial modulated symbols to parallel data in order to generate N parallel symbol streams, where N is the IFFT/FFT size used in the gNB 102 and the UE (e.g., UEs 111-116). The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to a RF frequency for transmission via a wireless channel. The signal may also be filtered at a baseband before conversion to the RF frequency.

As illustrated in FIG. 4B, the down-converter 455 down-converts the received signal to a baseband frequency, and the remove cyclic prefix block 460 removes the cyclic prefix to generate a serial time-domain baseband signal. The serial-to-parallel block 465 converts the time-domain baseband signal to parallel time-domain signals. The size N FFT block 470 performs an FFT algorithm to generate N parallel frequency-domain signals. The (P-to-S) block 475 converts the parallel frequency-domain signals to a sequence of modulated data symbols. The channel decoding and demodulation block 480 demodulates and decodes the modulated symbols to recover the original input data stream.

Each of the gNBs 101-103 may implement a transmit path 400 that is analogous to transmitting in the downlink to UEs 111-116 and may implement a receive path 450 that is analogous to receiving in the uplink from UEs 111-116. Similarly, each of UEs 111-116 may implement a transmit path 400 for transmitting in the uplink to gNBs 101-103, and/or for transmitting in the sidelink to another UE and may implement a receive path 450 for receiving in the downlink from gNBs 101-103 and/or for receiving in the sidelink for another UE.

Each of the components in FIGS. 4A and 4B can be implemented using only hardware or using a combination of hardware and software/firmware. As a particular example, at least some of the components in FIGS. 4A and 4B may be implemented in software, while other components may be implemented by configurable hardware or a mixture of software and configurable hardware. For instance, the FFT block 470 and the IFFT block 415 may be implemented as configurable software algorithms, where the value of size N may be modified according to the implementation.

Furthermore, although described as using FFT and IFFT, this is by way of illustration only and should not be construed to limit the scope of this disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 4A and 4B illustrate examples of wireless transmit and receive paths 400 and 450, respectively, various changes may be made to FIGS. 4A and 4B. For example, various components in FIGS. 4A and 4B can be combined, further subdivided, or omitted and additional components can be added according to particular needs. Also, FIGS. 4A and 4B are meant to illustrate examples of the types of transmit and receive paths that can be used in a wireless network. Any other suitable architectures can be used to support wireless communications in a wireless network.

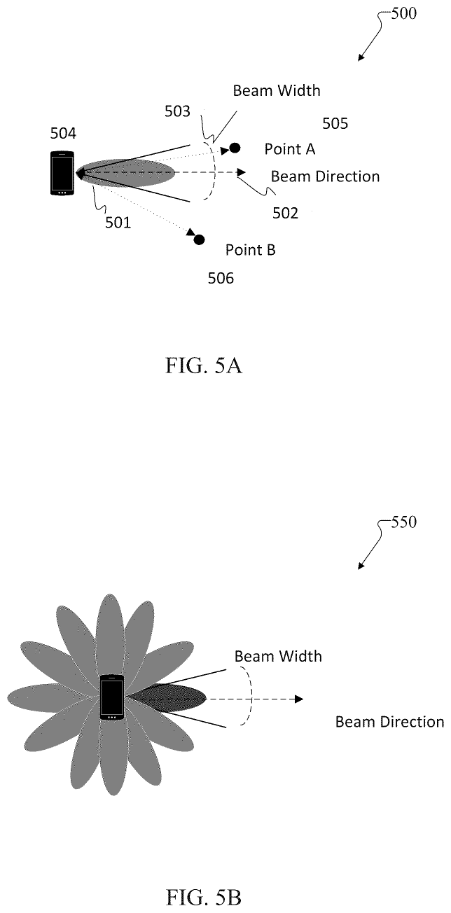

As illustrated in FIG. 5A, in a wireless system 500, a beam 501 for a device 504 can be characterized by a beam direction 502 and a beam width 503. For example, the device 504 (or UE) transmits RF energy in a beam direction and within a beam width. The device 504 receives RF energy in a beam direction and within a beam width. As illustrated in FIG. 5A, a device at point A 505 can receive from and transmit to device 504 as Point A is within a beam width and direction of a beam from device 504. As illustrated in FIG. 5A, a device at point B 506 cannot receive from and transmit to device 504 as Point B 506 is outside a beam width and direction of a beam from device 504. While FIG. 5A, for illustrative purposes, shows a beam in 2-dimensions (2D), it should be apparent to those skilled in the art, that a beam can be in 3-dimensions (3D), where the beam direction and beam width are defined in space.

FIG. 5B illustrates an example of a multi-beam operation 550 according to embodiments of the present disclosure. For example, the multi-beam operation 550 can be utilized by gNB 102 of FIG. 2. This example is for illustration only and other embodiments can be used without departing from the scope of the present disclosure.

In a wireless system, a device can transmit and/or receive on multiple beams. This is known as “multi-beam operation”. While FIG. 5B, for illustrative purposes, a beam is in 2D, it should be apparent to those skilled in the art, that a beam can be 3D, where a beam can be transmitted to or received from any direction in space.

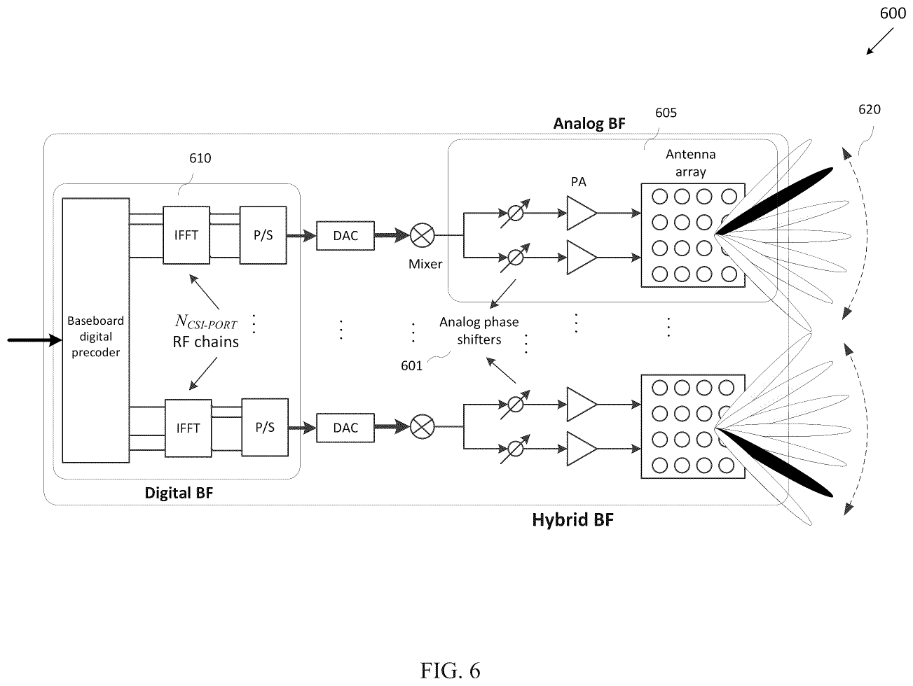

FIG. 6 illustrates an example of a transmitter structure 600 for beamforming according to embodiments of the present disclosure. In certain embodiments, one or more of gNB 102 or UE includes the transmitter structure 600. For example, one or more of antenna 205 and its associated systems or antenna 305 and its associated systems can be included in transmitter structure 600. This example is for illustration only and other embodiments can be used without departing from the scope of the present disclosure.

Accordingly, embodiments of the present disclosure recognize that Rel-14 LTE and Rel-15 NR support up to 32 CSI-RS antenna ports which enable an eNB or a gNB to be equipped with a large number of antenna elements (such as 64 or 128). A plurality of antenna elements can then be mapped onto one CSI-RS port. For mmWave bands, although a number of antenna elements can be larger for a given form factor, a number of CSI-RS ports, that can correspond to the number of digitally precoded ports, can be limited due to hardware constraints (such as the feasibility to install a large number of analog-to-digital converters (ADCs)/digital-to-analog converters (DACs) at mmWave frequencies) as illustrated in FIG. 6. Then, one CSI-RS port can be mapped onto a large number of antenna elements that can be controlled by a bank of analog phase shifters 601. One CSI-RS port can then correspond to one sub-array which produces a narrow analog beam through analog beamforming 605. This analog beam can be configured to sweep across a wider range of angles 620 by varying the phase shifter bank across symbols or slots/subframes. The number of sub-arrays (equal to the number of RF chains) is the same as the number of CSI-RS ports N_{CSI-PORT}. A digital beamforming unit 610 performs a linear combination across N_{CSI-PORT} analog beams to further increase a precoding gain. While analog beams are wideband (hence not frequency-selective), digital precoding can be varied across frequency sub-bands or resource blocks. Receiver operation can be conceived analogously.

Since the transmitter structure 600 of FIG. 6 utilizes multiple analog beams for transmission and reception (wherein one or a small number of analog beams are selected out of a large number, for instance, after a training duration that is occasionally or periodically performed), the term “multi-beam operation” is used to refer to the overall system aspect. This includes, for the purpose of illustration, indicating the assigned DL or UL or SL TX beam (also termed “beam indication”), measuring at least one reference signal for calculating and performing beam reporting (also termed “beam measurement” and “beam reporting”, respectively), and receiving a DL or UL or SL transmission via a selection of a corresponding RX beam. The system of FIG. 6 is also applicable to higher frequency bands such as >52.6 GHz. In this case, the system can employ only analog beams. Due to the O2 absorption loss around 60 GHz frequency (˜10 dB additional loss per 100 m distance), a larger number and narrower analog beams (hence a larger number of radiators in the array) are needed to compensate for the additional path loss.

A time unit for DL signaling, for UL signaling, or for SL signaling on a cell is one symbol. A symbol belongs to a slot that includes a number of symbols such as 14 symbols. A slot can also be used as a time unit. A bandwidth (BW) unit is referred to as a resource block (RB). One RB includes a number of sub-carriers (SCs). For example, a slot can have duration of one millisecond and an RB can have a bandwidth of 180 kHz and include 12 SCs with inter-SC spacing of 15 kHz. As another example, a slot can have a duration of 0.25 milliseconds and include 14 symbols and an RB can have a BW of 720 kHz and include 12 SCs with SC spacing of 60 KHz. An RB in one symbol of a slot is referred to as physical RB (PRB) and includes a number of resource elements (REs). A slot can be either full DL slot, or full UL slot, or hybrid slot similar to a special subframe in time division duplex (TDD) systems (see also REF 1). In addition, a slot can have symbols for SL communications or SL positioning. A UE can be configured one or more bandwidth parts (BWPs) of a system BW for transmissions or receptions of signals or channels.

SL signals and channels are transmitted and received on sub-channels within a resource pool, where a resource pool is a set of time-frequency resources used for SL transmission and reception within a SL BWP. SL channels include physical SL shared channels (PSSCHs) conveying data information and second stage/part SL control information (SCI), physical SL control channels (PSCCHs) conveying first stage/part SCI for scheduling transmissions/receptions of PSSCHs, physical SL feedback channels (PSFCHs) conveying hybrid automatic repeat request acknowledgement (HARQ-ACK) information in response to correct (ACK value) or incorrect (NACK value) transport block receptions in respective PSSCHs, PSFCHs can also convey conflict information, and physical SL Broadcast channel (PSBCH) conveying system information to assist in SL synchronization. SL signals include demodulation reference signals (DM-RSs) that are multiplexed in PSSCH or PSCCH transmissions to assist with data or SCI demodulation, channel state information reference signals (CSI-RS) for channel measurements, phase tracking reference signals (PT-RS) for tracking a carrier phase, and SL primary synchronization signals (S-PSS) and SL secondary synchronization signals (S-SSS) for SL synchronization and SL position reference signal (SL PRS) for SL positioning measurements. SCI can include two parts/stages corresponding to two respective SCI formats where, for example, the first SCI format is multiplexed on a PSCCH, and the second SCI format is multiplexed along with SL data on a PSSCH that is transmitted in physical resources indicated by the first SCI format.

A SL channel can operate in different cast modes. In a unicast mode, a PSCCH/PSSCH conveys SL information from one UE to only one other UE. In a groupcast mode, a PSCCH/PSSCH conveys SL information from one UE to a group of UEs within a (pre-) configured set. In a broadcast mode, a PSCCH/PSSCH conveys SL information from one UE to all surrounding UEs. In NR release 16, there are two resource allocation modes for a PSCCH/PSSCH transmission. In resource allocation mode 1, a gNB schedules a UE on the SL and conveys scheduling information to the UE transmitting on the SL through a downlink control information (DCI) format (e.g., DCI Format 3_0) transmitted from the gNB 102 on the DL. In resource allocation mode 2, a UE schedules a SL transmission. SL transmissions can operate within network coverage where each UE is within the communication range of a gNB, outside network coverage where all UEs have no communication with any gNB, or with partial network coverage, where only some UEs are within the communication range of a gNB.

In case of groupcast PSCCH/PSSCH transmission, a UE can be (pre-) configured one of two options for reporting of HARQ-ACK information by the UE:
1. HARQ-ACK reporting option (1): A UE can attempt to decode a transport block (TB) in a PSSCH reception if, for example, the UE detects a SCI format scheduling the TB reception through a corresponding PSSCH. If the UE fails to correctly decode the TB, the UE multiplexes a negative acknowledgement (NACK) in a PSFCH transmission. In this option, the UE does not transmit a PSFCH with a positive acknowledgment (ACK) when the UE correctly decodes the TB.
2. HARQ-ACK reporting option (2): A UE can attempt to decode a TB if, for example, the UE detects a SCI format that schedules a corresponding PSSCH. If the UE correctly decodes the TB, the UE multiplexes an ACK in a PSFCH transmission; otherwise, if the UE does not correctly decode the TB, the UE multiplexes a NACK in a PSFCH transmission.

In HARQ-ACK reporting option (1), when a UE that transmitted the PSSCH detects a NACK in a PSFCH reception, the UE can transmit another PSSCH with the TB (retransmission of the TB). In HARQ-ACK reporting option (2) when a UE that transmitted the PSSCH does not detect an ACK in a PSFCH reception, such as when the UE detects a NACK or does not detect a PSFCH reception, the UE can transmit another PSSCH with the TB.

A sidelink resource pool includes a set/pool of slots and a set/pool of RBs used for sidelink transmission and sidelink reception. A set of slots which belong to a sidelink resource pool can be denoted by {t′₀^{SL}, t′₁^{SL}, t′₂^{SL}, . . . , t′_{T′MAX-1}^{SL}} and can be configured, for example, at least using a bitmap, where T′MAX is the number of SL slots in a resource pool, e.g., within 1024 frames. Within each slot t′S4 of a sidelink resource pool, there are N_{subCH} contiguous sub-channels in the frequency domain for sidelink transmission, where N_{subCH} is provided by a higher-layer parameter. Subchannel m, where m is between 0 and N_{subCH}−1, is given by a set of n_{subCHsize} contiguous PRBs, given by n_{PRB}=n_{subCHstart}+m·n_{subCHsize}+j, where j=0, 1, . . . , n_{subCHsize}−1, n_{subCHstart} and n_{subCHsize} are provided by higher layer parameters.

For resource (re-) selection or re-evaluation in slot n, a UE can determine a set of available single-slot resources for transmission within a resource selection window [n+T₁, n+T₂], such that a single-slot resource for transmission R_{x,y} is defined as a set of L_{subCH} contiguous subchannels x+i, where i=0, 1, . . . , L_{subCH}−1 in slot t_{y}^{SL}. T₁ is determined by the UE such that, 0≤T₁≤T_{proc,1}^{SL}, where T_{proc,1}^{SL} is a PSSCH processing time for example as defined in TS 38.214 [REF4] Table 8.1.4-2. T₂ is determined by the UE such that T₂ min≤T₂≤Remaining Packet Delay Budget, as long as T₂ₘᵢₙ<Remaining Packet Delay Budget, else T₂ is equal to the Remaining Packet Delay Budget. T₂ₘᵢₙ is a configured by higher layers and depends on the priority of the SL transmission.

The slots of a SL resource pool are determined as follows:
1. Let set of slots that may belong to a resource be denoted by {t′₀^{SL}, t′₁^{SL}, t′₂^{SL}, . . . , t′_{T′MAX-1}^{SL}}, where 0≤tᵢ^{SL}<10240×2^{μ}, and 0≤i<Tₘₐₓ. μ is the sub-carrier spacing configuration. μ=0 for a 15 kHz sub-carrier spacing. μ=1 for a 30 kHz sub-carrier spacing. μ=2 for a 60 kHz sub-carrier spacing. μ=3 for a 120 kHz sub-carrier spacing. The slot index is relative to slot #0 of SFN #0 (system frame number 0) of the serving cell, or DFN #0 (direct frame number 0). The set of slots includes all slots except:
   a. N_{S-SSB} slots that are configured for SL synchronization signal/physical SL broadcast channels (S-SS/PSBCH) Block (S-SSB).
   b. N_{nonSL} slots where at least one SL symbol is not semi-statically configured as UL symbol by higher layer parameter tdd-UL-DL-ConfigurationCommon or sl-TDD-Configuration. In a SL slot, OFDM symbols Y-th, (Y+1)-th, . . . , (Y+X−1)-th are SL symbols, where Y is determined by the higher layer parameter sl-StartSymbol and X is determined by higher layer parameter sl-LengthSymbols.
   c. N_{reserved} reserved slots. Reserved slots are determined such that the slots in the set {t′₀^{SL}, t′₁^{SL}, t′₂^{SL}, . . . , t′_{T′MAX-1}^{SL}} is a multiple of the bitmap length (L_{bitmap}), where the bitmap (b₀, b₁, . . . , b_{L}_{_{bitmap}}₋₁) is configured by higher layers. The reserved slots are determined as follows:
      i. Let {l₀, l₁, . . . , l₂_{^{μ}}_{×10240-N}_{_{S-SSB}}_{-N}_{_{nonSL−1}}} be the set of slots in range 0 . . . 2^{μ}×10240−1, excluding S-SSB slots and non-SL slots. The slots are arranged in ascending order of the slot index.
      ii. The number of reserved slots is given by: N_{reserved}=(2^{μ}×10240−N_{S-SSB}−N_{nonSL}) mod L_{bitmap}.
      iii. The reserved slots L are given by:

$$r = ⌊ \frac{m \cdot ( {2}^{μ} \times 10240 - {N}_{S - SSB} - {N}_{nonSL} )}{{N}_{reserved}} ⌋ ,$$

where, m=0, 1, . . . , N_{reserved}−1. Tₘₐₓ is given by: Tₘₐₓ=2^{μ}×10240−N_{S-SSB}−N_{nonSL}−N_{reserved}.
2. The slots are arranged in ascending order of slot index.
3. The set of slots belonging to the SL resource pool, {t′₀^{SL}, t′₁^{SL}, t′₂^{SL}, . . . , t′_{T′MAX-1}^{SL}}, are determined as follows:
   a. Each resource pool has a corresponding bitmap (b₀, b₁, . . . , b_{L}_{_{bitmap}}₋₁) of length L_{bitmap}.
   b. A slot tₖ^{SL} belongs to the SL resource pool if b_{k modL}_{_{bitmap}}=1
   c. The remaining slots are indexed successively staring from 0, 1, . . . . T′_{MAX}−1, where T′_{MAX} is the number of remaining slots in the set.

Slots can be numbered (indexed) as physical slots or logical slots, wherein physical slots include all slots numbered sequential, while logical slots include only slots that are allocated to sidelink resource pool as described herein numbered sequentially. The conversion from a physical duration, Pᵣₛᵥₚ, in milli-second to logical slots, P′ᵣₛᵥₚ, is given by

$${P}_{rsvp}^{′} = ⌈ \frac{T {′}_{max}}{10240 ms} \times {P}_{rsvp} ⌉$$

(see section 8.1.7 of 38.214 [4]).

For resource (re-) selection or re-evaluation in slot n, a UE can determine a set of available single-slot resources for transmission within a resource selection window [n+T₁, n+T₂], such that a single-slot resource for transmission, R_{x,y} is defined as a set of L_{subCH} contiguous subchannels x+i, where i=0, 1, . . . , L_{subCH}−1 in slot t_{y}^{SL}. T₁ is determined by the UE such that, 0≤T₁≤T_{proc,1}^{SL}, where T_{proc,1}SL is a PSSCH processing time for example as defined in 3GPP standard specification TS 38.214 [REF4] Table 8.1.4-2. T₂ is determined by the UE such that T₂ₘᵢₙ≤T₂≤Remaining Packet Delay Budget as long as T₂ₘᵢₙ<Remaining Packet Delay Budget, else T₂ is equal to the Remaining Packet Delay Budget. T₂ min is configured by higher layers and depends on the priority of the SL transmission.

The resource (re-) selection is a two-step procedure:
1. The first step (e.g., performed in the physical layer) is to identify the candidate resources within a resource selection window. Candidate resources are resources that belong to a resource pool, but exclude resources (e.g., resource exclusion) that were previously reserved, or potentially reserved by other UEs. The resources excluded are based on SCIs decoded in a sensing window and for which the UE measures a SL reference signal received power (RSRP) that exceeds a threshold. The threshold depends on the priority indicated in a SCI format and on the priority of the SL transmission. Therefore, sensing within a sensing window involves decoding the first stage SCI, and measuring the corresponding SL RSRP, wherein the SL RSRP can be based on PSCCH demodulation reference signal (DMRS) or PSSCH DMRS. Sensing is performed over slots where the UE does not transmit SL. The resources excluded are based on reserved transmissions or semi-persistent transmissions that can collide with the excluded resources or any of reserved or semi-persistent transmissions. The identified candidate resources after resource exclusion are provided to higher layers.
2. The second step (e.g., performed in the higher layers) is to select or re-select a resource from the identified candidate resources for PSSCH/PSCCH transmission.

During the first step of the resource (re-) selection procedure, a UE can monitor slots in a sensing window [n−T₀, n−T_{proc,0}^{SL}), where the UE monitors slots belonging to a corresponding sidelink resource pool that are not used for the UE's own transmission. For example, T_{proc,0}^{SL} is the sensing processing latency time, for example as defined in 3GPP standard specification, TS 38.214 [REF4] Table 8.1.4-1. To determine a candidate single-slot resource set to report to higher layers, a UE excludes (e.g., resource exclusion) from the set of available single-slot resources for SL transmission within a resource pool and within a resource selection window, the following:
1. Single slot resource R_{x,y}, such that for any slot t′ₘ^{SL} not monitored within the sensing window with a hypothetical received SCI Format 1-0, with a “Resource reservation period” set to any periodicity value allowed by a higher layer parameter reservationPeriodAllowed, and indicating all sub-channels of the resource pool in this slot, satisfies condition 2.2. herein.
2. Single slot resource R_{x,y}, such that for any received SCI within the sensing window:
   a. The associated L1-RSRP measurement is above a (pre-) configured SL-RSRP threshold, where the SL-RSRP threshold depends on the priority indicated in the received SCI and that of the SL transmission for which resources are being selected.
   b. (Condition 2.2) The received SCI in slot t′ₘ^{SL}, or if “Resource reservation field” is present in the received SCI the same SCI is assumed to be received in slot t′_{m+q×P′}_{_{rsvp_Rx}}^{SL}, indicates a set of resource blocks that overlaps R_{x,y+j×P′}_{_{rsvp_Tx}}. Where,
      i. q=1, 2, . . . , Q, where,

$$If {P}_{rsvp \_ RX} \leq {T}_{scal} and {n}^{′} - m < {P}_{rsvp \_ Rx}^{′} \to Q = ⌈ \frac{{T}_{scal}}{{P}_{rsvp \_ RX}} ⌉ . {T}_{scal}$$

is T₂ in units of milli-seconds.
Else Q=1.
If n belongs to {t′₀^{SL}, t′₁^{SL}, t′₂^{SL}, . . . , t′_{T′MAX-1}^{SL}}, n′=n, else n′ is the first slot after slot n belonging to set {t′₀^{SL}, t′₁^{SL}, t′₂^{SL}, . . . , t′_{T′MAX-1}^{SL}}.
ii. j=0, 1, . . . , Cᵣₑₛₑₗ−1
iii. P_{rsvp_RX} is the indicated resource reservation period in the received SCI in physical slots, and P′ rsvp_Rx is that value converted to logical slots.
iv. P′_{rsvp_Tx} is the resource reservation period of the SL transmissions for which resources are being reserved in logical slots.
3. If the candidate resources are less than a (pre-) configured percentage given by higher layer parameter sl_TxPrecentageList (prio_{TX}) that depends on the priority of the SL transmission prio_{TX}, such as 20% of the total available resources within the resource selection window, the (pre-) configured SL-RSRP thresholds are increased by a predetermined amount, such as 3 dB.

NR sidelink introduced two new procedures for mode 2 resource allocation: re-evaluation and pre-emption.

Re-evaluation check occurs when a UE checks the availability of pre-selected SL resources before the resources are first signaled in an SCI Format, and if needed re-selects new SL resources. For a pre-selected resource to be first-time signaled in slot m, the UE performs a re-evaluation check at least in slot m−T₃. The re-evaluation check includes:
1. Performing the first step of the SL resource selection procedure as defined in the 3GPP specifications [i.e., 38.214 clause 8.1.4] which involves identifying a candidate (available) sidelink resource set in a resource selection window as previously described.
2. If the pre-selected resource is available in the candidate sidelink resource set, the resource is used/signaled for sidelink transmission.
3. Else, the pre-selected resource is not available in the candidate sidelink resource set, a new sidelink resource is re-selected from the candidate sidelink resource set.

Pre-emption check occurs when a UE checks the availability of pre-selected SL resources that have been previously signaled and reserved in an SCI Format and, if needed, re-selects new SL resources. For a pre-selected and reserved resource to be signaled in slot m, the UE performs a pre-emption check at least in slot m−T₃. When pre-emption check is enabled by higher layers, pre-emption check includes:
1. Performing the first step of the SL resource selection procedure as defined in the 3GPP specifications [i.e., 38.214 clause 8.1.4], which involves identifying candidate (available) sidelink resource set in a resource selection window as previously described.
2. If the pre-selected and reserved resource is available in the candidate sidelink resource set, the resource is used/signaled for sidelink transmission.
3. Else, the pre-selected and reserved resource is NOT available in the candidate sidelink resource set. The resource is excluded from the candidate resource set due to an SCI, associated with a priority value P_{RX}, having an RSRP exceeding a threshold. Let the priority value of the sidelink resource being checked for pre-emption be P_{TX}.
If the priority value P_{RX} is less than a higher-layer configured threshold and the priority value P_{RX} is less than the priority value P_{TX}. The pre-selected and reserved sidelink resource is pre-empted. A new sidelink resource is re-selected from the candidate sidelink resource set. Note that, a lower priority value indicates traffic of higher priority.
Else, the resource is used/signaled for sidelink transmission.

As described herein, the monitoring procedure for resource (re) selection during the sensing window requires reception and decoding of a SCI format during the sensing window as well as measuring the SL RSRP. This reception and decoding process and measuring the SL RSRP increases a processing complexity and power consumption of a UE for sidelink communication and requires the UE to have receive circuitry on the SL for sensing even if the UE only transmits and does not receive on the sidelink. The sensing procedure mentioned herein is referred to a full sensing.

3GPP Release 16 is the first NR release to include sidelink through work item “5G V2X with NR sidelink”, the mechanisms introduced focused mainly on vehicle-to-everything (V2X) and can be used for public safety when the service requirement can be met. Release 17 extends sidelink support to more use cases through work item “NR Sidelink enhancement” (RP-201385). The objectives of Rel-17 SL include: (1) Resource allocation enhancements that reduce power consumption and (2) enhanced reliability and reduced latency.

Rel-17 introduced low-power resource allocation. Low-power resource allocation schemes include partial sensing and random resource selection. If a SL transmission from a UE is periodic, partial sensing can be based on periodic-based partial sensing (PBPS), and/or contiguous partial sensing (CPS). If a SL transmission from a UE is aperiodic, partial sensing can be based on CPS and PBPS if the resource pool supports periodic reservations (i.e., sl_multiReserveResource is enabled). When a UE performs PBPS, the UE selects a set of Y slots (Y≥Yₘᵢₙ) within a resource selection window corresponding to PBPS, where Yₘᵢₙ is provided by higher layer parameter minNumCandidateSlotsPeriodic. The UE monitors slots at t′_{y-k×P}_{ᵣₑₛₑᵣᵥₑ}^{SL}, where t′_{y}^{SL} is a slot of the Y selected candidate slots. The periodicity value for sensing for PBPS, i.e., Pᵣₑₛₑᵣᵥₑ is a subset of the resource reservation periods allowed in a resource pool provided by higher layer parameter sl-ResourceReservePeriodList. Pᵣₑₛₑᵣᵥₑ is provided by higher layer parameter periodicSensingOccasionReservePeriodList and, if not configured, Pᵣₑₛₑᵣᵥₑ includes all periodicities in sl-ResourceReservePeriodList. The UE monitors k sensing occasions determined by additionalPeriodicSensingOccasion, as previously described, and not earlier than n−T₀. For a given periodicity Pᵣₑₛₑᵣᵥₑ, the values of k correspond to the most recent sensing occasion earlier than t′_{y0}^{SL}−(T_{proc,0}^{SL}+T_{proc,1}^{SL}) if additionalPeriodicSensingOccasion is not (pre-) configured, and additionally includes the value of k corresponding to the last periodic sensing occasion prior to the most recent one if additionalPeriodicSensingOccasion is (pre-) configured. t′_{y0}^{SL} is the first slot of the selected Y candidate slots of PBPS. When a UE performs CPS, the UE selects a set of Y′ slots (Y′≥ Y′ₘᵢₙ) within a resource selection window corresponding to CPS, where Y′ₘᵢₙ is provided by higher layer parameter minNumCandidateSlotsAperiodic. The sensing window for CPS starts at least M logical slots before t′_{y0}^{SL}(the first of the Y′ candidate slots) and ends at t′_{y0}^{SL}−(T_{proc,0}^{SL}+T_{proc,1}^{SL}).

Rel-17 introduced inter-UE co-ordination (IUC) to enhance the reliability and reduce the latency for resource allocation, where SL UEs exchange information with one another over sidelink to aid the resource allocation mode 2 (re-) selection procedure. UE-A provides information to UE-B, and UE-B uses the provided information for its resource allocation mode 2 (re-) selection procedure. IUC is designed to address issues with distributed resource allocation such as: (1) Hidden node problem, where a UE-B is transmitting to a UE-A and UE-B can't sense or detect transmissions from a UE-C that interfere with its transmission to a UE-A, (2) Exposed node problem, where a UE-B is transmitting to a UE-A, and UE-B senses or detects transmissions from a UE-C and avoids the resources used or reserved by UE-C, but UE-C doesn't cause interference at UE-A, (3) Persistent collision problem, and (4) Half-duplex problem, where UE-B is transmitting to a UE-A in the same slot that UE-A is transmitting in, UE-A will miss the transmission from UE-B as UE-A cannot receive and transmit in the same slot.

There are two schemes for inter-UE co-ordination:
1. In one example, in scheme 1, a UE-A can provide to another UE-B indications of resources that are preferred to be included in UE-B's (re-) selected resources, or non-preferred resources to be excluded for UE-B's (re-) selected resources. When given preferred resources, UE-B may use only those resources for its resource (re-) selection, or UE-B may combine them with resources identified by its own sensing procedure, e.g., by finding the intersection of the two sets of resources, for its resource (re-) selection. When given non-preferred resources, UE-B may exclude these resources from resources identified by its own sensing procedure for its resource (re-) selection.
   Transmissions of co-ordination information (e.g., IUC messages) transmitted by UE-A to UE-B, and co-ordination information requests (e.g., IUC requests) transmitted by UE-A to UE-B, are transmitted in a MAC-CE message and may also, if supported by the UEs, be transmitted in a 2^{nd}-stage SCI Format (SCI Format 2-C). The benefit of using the 2nd stage SCI is to reduce latency. IUC messages from UE-A to UE-B can be transmitted standalone or can be combined with other SL data. Coordination information (IUC messages) can be in response to a request from UE-B, or due to a condition at UE-A. An IUC request is unicast from UE-B to UE-A, in response UE-A transmits an IUC message in unicast mode to UE-B. An IUC message transmitted as a result of an internal condition at UE-A can be unicast to UE-B, when the IUC message includes preferred resources, or can be unicast, groupcast or broadcast to UE-B when the IUC message includes non-preferred resources. UE-A can determine preferred or non-preferred resources for UE-B based on its own sensing taking into account the SL-RSRP measurement of the sensed data and the priority of the sensed data, i.e., the priority field of the decoded PSCCH during sensing as well as the priority the traffic transmitted by UE-B in case of request-based IUC or a configured priority in case of condition-based IUC. Non-preferred resource to UE-B can also be determined to avoid the half-duplex problem, where UE-A cannot receive data from a UE-B in the same slot UE-A is transmitting.
2. In another example, in scheme 2, a UE-A can provide to another UE-B an indication that resources reserved for UE-B's transmission, whether or not UE-A is the destination UE of these resources, are subject to conflict with a transmission from another UE. UE-A determines the conflicting resources based on the priority and RSRP of the transmissions involved in the conflict. UE-A can also determine a presence of a conflict due to the half-duplex problem, where UE-A cannot receive a reserved resource from UE-B at the same time UE-A is transmitting. When UE-B receives a conflict indication for a reserved resource, UE-B can re-select new resources to replace them.
   The conflict information from UE-A is transmitted in a PSFCH channel separately (pre-) configured from the PSFCH of the SL-HARQ operation. The timing of the PSFCH channel carrying conflict information can be based on the SCI indicating reserved resource or based on the reserved resource.

In both schemes, UE-A can identify resources according to a number of conditions which are based on the SL-RSRP of the resources in question as a function of the traffic priority, and/or whether UE-A would be unable to receive a transmission from UE-B, due to performing its own transmission, i.e., a half-duplex problem. The purpose of this exchange of information is to give UE-B information about resource occupancy acquired by UE-A which UE-B might not be able to determine on its own due to hidden nodes, exposed nodes, persistent collisions, etc.

Release 18 enhances further evolution of the NR SL air interface for operation in unlicensed bands, beam-based operation in FR2, SL carrier aggregation and co-channel co-existence between LTE SL and NR SL.

On the Uu interface a beam is determined by either of:
A transmission configuration indication (TCI) state, which establishes a quasi-colocation (QCL) relationship between a source reference signal (e.g., SSB and/or CSI-RS) and a target reference signal.
A spatial relation information that establishes an association to a source reference signal, such as SSB or CSI-RS or sounding reference signal (SRS).

In either case, the ID of the source reference signal identifies the beam.

Terminology such as TCI, TCI states, SpatialRelationInfo, target RS, reference RS, and other terms is used for illustrative purposes and is therefore not normative. Other terms that refer to same functions can also be used.

Rel-17 introduced the unified TCI framework, where a unified or master or main or indicated TCI state is signaled or indicated to the UE. The unified or master or main or indicated TCI state can be one of:
1. In case of joint TCI state indication, wherein a same beam is used for DL and UL channels, a joint TCI state that can be used at least for UE-dedicated DL channels and UE-dedicated UL channels.
2. In case of separate TCI state indication, wherein different beams are used for DL and UL channels, a DL TCI state that can be used at least for UE-dedicated DL channels.
3. In case of separate TCI state indication, wherein different beams are used for DL and UL channels, a UL TCI state that can be used at least for UE-dedicated UL channels.

The unified (master or main or indicated) TCI state is a DL or a Joint TCI state of UE-dedicated reception on physical downlink shared channel (PDSCH)/physical downlink control channel (PDCCH) and the CSI-RS applying the indicated TCI state and/or an UL or a Joint TCI state for dynamic-grant/configured-grant based physical uplink shared channel (PUSCH), physical uplink control channel (PUCCH), and SRS applying the indicated TCI state.

The unified TCI framework applies to intra-cell beam management, wherein, the TCI states have a source RS that is directly or indirectly associated, through a quasi-co-location relation, e.g., spatial relation, with an SSB of a serving cell (e.g., the TCI state is associated with a TRP of a serving cell). The unified TCI state framework also applies to inter-cell beam management, wherein a TCI state can have a source RS that is directly or indirectly associated, through a quasi-co-location relation, e.g., spatial relation, with an SSB of cell that has a physical cell identity (PCI) different from the PCI of the serving cell (e.g., the TCI state is associated with a TRP of a cell having a PCI different from the PCI of the serving cell). In Rel-17, UE-dedicated channels can be received and/or transmitted using a TCI state associated with a cell having a PCI different from the PCI of the serving cell. While the common channels can be received and/or transmitted using a TCI state associated with the serving cell (e.g., not associated with a cell having a PCI different from the PCI of the serving cell). Common channels can include:
Channels carrying system information (e.g., SIB) with a DL assignment carried by a DCI in PDCCH having a CRC scrambled by system information (SI)-RNTI and transmitted in Type0-PDCCH common search space (CSS) set.
Channels carrying other system information with a DL assignment carried by a DCI in PDCCH having a CRC scrambled by SI-RNTI and transmitted in Type0A-PDCCH CSS set.
Channels carrying paging or short messages with a DL assignment carried by a DCI in PDCCH having a CRC scrambled by paging radio network temporary identifier (P-RNTI) and transmitted in Type2-PDCCH CSS set.
Channels carrying random access channel (RACH) related channels with a DL assignment or UL grant carried by a DCI in PDCCH having a CRC scrambled by random access (RA)-RNTI or temporary cell (TC)-RNTI and transmitted in Type1-PDCCH CSS set.

A DL-related DCI Format (e.g., DCI Format 1_1 or DCI Format 1_2), with or without DL assignment, can indicate to a UE through a field “transmission configuration indication” a TCI state code point, wherein, the TCI state codepoint can be one of (1) a DL TCI state; (2) an UL TCI state; (3) a joint TCI state; or (4) a pair of DL TCI state and UL TCI state. TCI state code points are activated by MAC CE signaling.

Quasi-co-location (QCL) relation, can be quasi-location with respect to one or more of the following relations [38.214 [REF4]-section 5.1.5]:
Type A, {Doppler shift, Doppler spread, average delay, delay spread}
Type B, {Doppler shift, Doppler spread}
Type C, {Doppler shift, average delay}
Type D, {Spatial Rx parameter}

In addition, quasi-co-location relation can also provide a spatial relation for UL channels, e.g., a DL source reference signal provides information on the spatial domain filter to be used for UL transmissions, or the UL source reference signal provides the spatial domain filter to be used for UL transmissions, e.g., same spatial domain filter for UL source reference signal and UL transmissions.

The unified (master or main or indicated) TCI state applies at least to UE dedicated DL and UL channels. The unified (master or main or indicated) TCI can also apply to other DL and/or UL channels and/or signals e.g., non-UE dedicated channel and sounding reference signal (SRS).

A “reference RS” corresponds to a set of characteristics of a DL beam or an UL TX beam, such as a direction, a precoding/beamforming, a number of ports, and so on.

On a Uu interface, a TCI state can be used for beam indication. It can refer to a DL TCI state for downlink channels (e.g., PDCCH and PDSCH), an uplink TCI state for uplink channels (e.g., PUSCH or PUCCH), a joint TCI state for downlink and uplink channels, or separate TCI states for uplink and downlink channels. A TCI state can be common across multiple component carriers or can be a separate TCI state for a component carrier or a set of component carriers. A TCI state can be gNB or UE panel specific or common across panels. In some examples, the uplink TCI state can be replaced by SRS resource indicator (SRI).

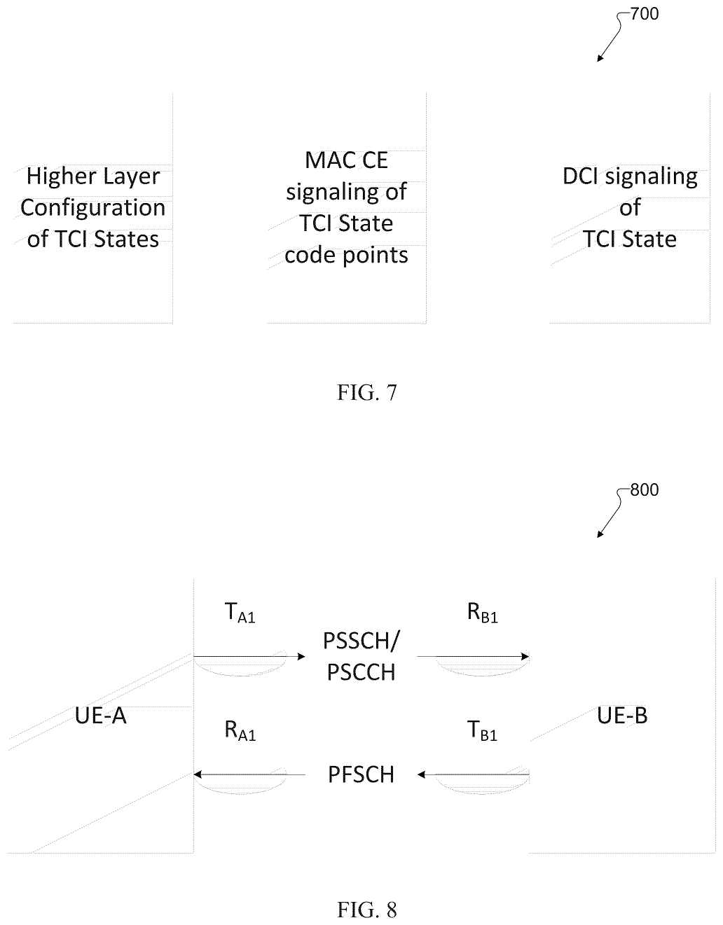

FIG. 7 illustrates a diagram of an example MAC CE signaling 700 according to embodiments of the present disclosure. For example, MAC CE signaling 700 can be received by any of the UEs 111-116 of FIG. 1. This example is for illustration only and other embodiments can be used without departing from the scope of the present disclosure.

A UE can be configured/updated through higher layer RRC signaling (as illustrated in FIG. 7) a set of TCI States with N elements. In one example, DL and joint TCI states are configured by higher layer parameter DLorJoint-TCIState, wherein, the number of DL and Joint TCI state is N_{DJ}. UL TCI state are configured by higher layer parameter UL-TCIState, wherein the number of UL TCI state is N_{U}. N=N_{DJ}+N_{U}. The DLorJoint-TCIState can include DL or Joint TCI states that belong to a serving cell, e.g., the source RS of the TCI state is associated with the serving cell (the PCI of the serving cell). Additionally, the DL or Joint TCI states can be associated with a cell having a PCI different from the PCI of the serving cell, e.g., the source RS of the TCI state is associated with a cell having a PCI different from the PCI of the serving cell. The UL-TCIState can include UL TCI states that belong to a serving cell, e.g., the source RS of the TCI state is associated with the serving cell (the PCI of the serving cell). Additionally, the UL TCI states can be associated with a cell having a PCI different from the PCI of the serving cell, e.g., the source RS of the TCI state is associated with a cell having a PCI different from the PCI of the serving cell.

With reference to FIG. 7, MAC CE signaling includes activating a subset of M (MSN) TCI states or TCI state code points from the set of N TCI states, wherein a code point is signaled in the “transmission configuration indication” field a DCI used for indication of the TCI state. A codepoint can include one TCI state (e.g., DL TCI state or UL TCI state or Joint (DL and UL) TCI state). Alternatively, a codepoint can include two TCI states (e.g., a DL TCI state and an UL TCI state). L1 control signaling (i.e., Downlink Control Information (DCI)) updates the UE's TCI state, wherein the DCI includes a “transmission configuration indication” (beam indication) field e.g., with m bits (such that M≤2^{m}), the TCI state corresponds to a code point signaled by MAC CE. A DCI used for indication of the TCI state can be DL related DCI Format (e.g., DCI Format 1_1 or DCI Format 1_2), with a DL assignment or without a DL assignment.

On the Uu interface, the PHY layer determines a beam failure detection instance when RSRP of a beam failure detection reference signal (BFD RS) is less than a threshold. The BFD RS can be a periodic CSI-RS. When the PHY layer detects a beam failure instance, an indication is sent to the MAC layer. The MAC layer starts a timer (beamFailureDetectionTimer) and increments a counter (BFI_COUNTER) by 1. If the counter reaches or exceeds a threshold (beamFailureInstanceMaxCount) before the timer expired, beam failure recovery is triggered for this BFD-RS. If the timer expired, the counter (BFI_COUNTER) is reset to zero. When beam failure recovery is triggered, the UE identifies a new beam from the candidate beam list, wherein the candidate beam list can be periodic CSI-RS or SS/PBCH Block (SSB). The UE transmits a beam failure recovery request (BFRQ) to the network, wherein the BFRQ includes an indication on the newly identified beam. The network responds with a beam failure recovery response (BFRR) and after a time from the BFRR, the UE applies the new beam which completes the beam failure recovery procedure. For primary secondary cell (PsCell), the BFRQ is physical random access channel (PRACH) based and BFRR is transmitted in the recovery search space. For SCell, the UE uses the PsCell for recovery of the SCell when the SCell fails. The UE transmits SR on PUCCH for BFR. After getting an uplink grant, the UE transmits a PUSCH that includes the BFR MAC CE, the BFR MAC CE includes the index of the SCell(s) with beam failure and newly identified candidate beam. The network responds with a PDCCH with a new UL grant for the same HARQ process as the BFR MAC CE and addressed to the C-RNTI.

Embodiments of the present disclosure recognize evaluation for beam failure detection and beam failure recovery for SL in FR2 are needed. The following aspects are evaluated: (1) Signal or channel used for beam failure detection and beam failure detection condition, (2) Signal or channel used for identifying new beams, (3) Beam failure recovery request, and (4) Beam failure recovery response.

3GPP Release 16 is the first NR release to include sidelink through work item “5G V2X with NR sidelink”, the mechanisms introduced focused mainly on vehicle-to-everything (V2X) and can be used for public safety when the service requirement can be met. Release 17 extends sidelink support to more use cases through work item “NR Sidelink enhancement” (RP-201385). Release 18 evaluates further evolution of the NR SL air interface for operation in unlicensed bands, beam-based operation in FR2, SL carrier aggregation and co-channel co-existence between LTE SL and NR SL. One of the key features of NR is its ability to support beam-based operation. This is especially important for operation in FR2 which suffers a higher propagation loss. In Rel-16 and Rel-17 the main focus of developing SL was FR1. Indeed, the frequency bands supported for SL in Rel-16 and Rel-17 are all sub-6 GHZ frequencies (bands n14, n38, n47, and n79). One of the objectives of Rel-18 is to expand SL to FR2. While SL supports SL phase tracking reference signal (PTRS), an important feature to support operation in FR2, i.e., beam management, is missing. Beam management includes several procedures, (1) initial beam pairing, (2) beam maintenance, and (3) beam failure recovery.

This disclosure provides for design of beam failure detection and beam failure recovery on the SL (e.g., PC5) interface.

The first step of beam failure detection and recovery is to detect a beam failure. On the Uu interface, as mentioned herein, periodic reference signals (e.g., periodic CSI-RS) are configured for beam failure detection, periodic CSI-RS is transmitted by the network and can be shared by multiple UEs, hence reducing the signaling overhead (in contrast to having different CSI-RS resources for each UE). While the same can be done on the SL interface, this increases the signaling overhead, given the periodic RS would be configured and transmitted by each UE in the network. In this disclosure, other signals and channels can be used for BFD, as well as trigger conditions for BFD-RS to reduce signaling overhead.

The second step of beam failure detection is to identify new candidate beams. On the Uu interface, as mentioned herein, periodic reference signals (e.g., periodic CSI-RS or SSB) are configured for the candidate RS set to identify new beams. As mentioned herein, the periodic RS resources can be shared by multiple UEs to reduce overhead. While the same can be done on the SL interface, this increases the signaling overhead, given the periodic RS would be configured and transmitted by each UE in the network. In this disclosure, methods are provided to reduce the overhead of candidate RS for identifying new beams.

The third step is for a first UE to inform the second UE of the newly identified beam. This is beam failure recovery request (BFRQ). On the Uu interface, as mentioned herein, this is done by using RACH for the PsCell, or using BFR SR followed by BFR MAC CE for the SCell. In SL, there is no RACH-like channel, while a RACH-like channel can be designed, various embodiments of the present disclosure provide alternative methods to indicate the beam.

The fourth step is for the first UE to get confirmation from the second UE. This is beam failure recovery response (BFRR). After the BFRR by a delay, the newly found beam can be applied.

The Uu interface is a centralized system, where the base station communicates with the UEs in the base stations serving cell. The SL (e.g., PC5 interface) is distributed system, with direct pear-to-pear communication. This can lead to the following challenges: (1) higher overhead for reference signals used for BFD and new beam identification and (2) for a link between two UEs (a first UE and a second UE), beam failure can occur at the first UE or at the second UE or at both the first and the second UEs; beam failure detection and recovery can be designed to handle these scenarios.

The present disclosure relates to a 5G/NR communication system.

This disclosure evaluates aspects related to beam failure detection and recovery: (1) Channels and/or signals used for beam failure detection. (2) Channels and/or signals used for identifying new beams. (3) methods to indicate and apply new beam.

Aspects, features, and advantages of the disclosure are readily apparent from the following detailed description, simply by illustrating a number of particular embodiments and implementations, including the best mode contemplated for carrying out the disclosure. The disclosure is also capable of other and different embodiments, and its several details can be modified in various respects, all without departing from the spirit and scope of the disclosure. Accordingly, the drawings and description are to be regarded as illustrative in nature, and not as restrictive.

The disclosure is illustrated by way of example, and not by way of limitation, in the figures of the accompanying drawings.

A description of example embodiments is provided on the following pages.

FIG. 8 illustrates a diagram of an example PSSCH/PSCCH and PSFCH transmission 800 according to embodiments of the present disclosure. For example, PSSCH/PSCCH and PSFCH transmission 800 can be transmitted/received by any of the UEs 111-116 of FIG. 1, such as the UE 111 and UE 111A. This example is for illustration only and other embodiments can be used without departing from the scope of the present disclosure.

In this disclosure, configuration by RRC signaling can be over Uu interface and/or over PC5 interface. The RRC signaling can be UE common RRC signaling (e.g., SIB signaling) or UE dedicated RRC signaling. MAC CE signaling can be by Uu interface and/or over PC5 interface, L1 control signaling can be by DCI and/or SCI (first stage SCI and/or second stage SCI) and/or PSFCH.

In SL, “reference RS” can correspond to a set of characteristics for SL beam, such as a direction, a precoding/beamforming, a number of ports, and so on. This can correspond to a SL receive beam or to a SL transmit beam. At least two UEs are involved in a SL communication, for example, a first UE (such as UE 111) as UE-A and a second UE (such as UE 111A, 11B, or 111C) as UE-B. In one example, UE-A is transmitting SL data on PSSCH/PSCCH, and UE-B is receiving the SL data on PSSCH/PSCCH; however, the roles of UE-A and UE-B can be reversed such that UE-B is transmitting SL data and UE-A is receiving SL data, and other SL channels or signals can be transmitted or received.

For mmWave bands (or FR2) or for higher frequency bands (such as >52.6 GHz) where multi-beam operation is especially relevant, a transmission-reception process includes a receiver in a second UE (e.g., UE-B) selecting a receive (RX) beam for a given TX beam from a first UE (e.g., UE-A). The selection of the Rx beam can be based on measurements at UE-B's decision or based on beam indication from UE-A as mentioned herein in FIG. 8. UE-A and UE-B may or may not be in coverage of a network.

In this disclosure a beam is also referred to as a spatial domain filter. For example, a transmit beam is a spatial domain transmission (or transmit) filter, and a receive beam is a spatial domain reception (or receive) filter.

In this disclosure, RRC signaling (e.g., configuration by RRC signaling) includes the following: (1) RRC signaling over the Uu interface; this can be system information block (SIB)-based RRC signaling (e.g., SIB1 or other SIB) or RRC dedicated signaling that is transmitted to a specific UE, and/or (2) PC5-RRC signaling over the PC5 or SL interface.

In this disclosure MAC CE signaling includes: (1) MAC CE signaling over the Uu interface, and/or (2) MAC CE signaling over the PC5 or SL interface.

In this disclosure L1 control signaling includes: (1) L1 control signaling over the Uu interface; this can include (1a) DL control information (e.g., DCI on PDCCH) and/or (1b) UL control information (e.g., unlink control information (UCI) on PUCCH or PUSCH), and/or (2) SL control information over the PC5 or SL interface; this can include (2a) first stage sidelink control information (e.g., first stage SCI on PSCCH), and/or (2b) second stage sidelink control information (e.g., second stage SCI on PSSCH) and/or (2c) feedback control information (e.g., control information carried on PSFCH).

In this disclosure a beam report or beam measurement report can be (1) a periodic report, e.g., preconfigured or configured by higher layers, (2) a semi-persistent report that is activated and/or deactivated by MAC CE signaling and/or L1 control signaling, or (3) aperiodic report that is triggered by L1 control signaling and/or MAC CE signaling.

In this disclosure, the container of a report (e.g., beam report (or beam measurement report) or a beam indication message or beam failure recovery request (BFRQ) or beam failure recovery response (BFRR)) can be:
MAC CE report. For example, MAC CE report can reuse the MAC CE CSI report on the SL PC5 interface.
SCI report container, the SCI report container can be first stage SCI (e.g., conveyed by PSCCH) and/or a second stage SCI (e.g., conveyed by PSSCH). In one example, the second stage SCI is a standalone second stage SCI in PSSCH, with no sidelink shared channel (SL-SCH) in PSSCH. In another example, the second stage SCI is multiplexed in PSSCH with a MAC CE carrying the report with no other SL data. In another example, the second stage SCI is multiplexed in PSSCH with a MAC CE carrying the report and other SL data. In another example, the second stage SCI is multiplexed in PSSCH with other SL data e.g., in a SL-SCH.
PSFCH report container. In one example, the PSFCH can be redesigned to carry more than one bit of information, e.g., a PSFCH with N bits of information and N>1. In one example, a report is one bit, for example, indicating if a beam is good (e.g., valid) or bad (e.g., invalid). In one example, a report is N bits, with N being a small number and N PSFCHs are used.
If a UE is in network coverage, the report can be transmitted to the network using UCI on PUCCH or PUSCH and/or the report can be transmitted to the network using MAC CE on the Uu interface.

In this disclosure, a beam can be identified for communication between a first UE (such as UE 111) and a second UE (such as UE 111A, 111B, or 111C). In one example for the first UE, a same beam is used to transmit PSSCH/PSCCH and PSFCH from the first UE to the second UE. In one example, for the first UE, a same beam is used to receive PSSCH/PSCCH and PSFCH at the first UE from the second UE. In one example for the first UE, different beams are used to transmit PSSCH/PSCCH and PSFCH from the first UE to the second UE. In one example, for the first UE, different beams are used to receive PSSCH/PSCCH and PSFCH at the first UE from the second UE. In one example for the first UE, different beams are used to transmit PSSCH and PSCCH from the first UE to the second UE. In one example, for the first UE, different beams are used to receive PSSCH and PSCCH at the first UE from the second UE. The roles of the first and second UEs can be interchanged.

In one example, a UE can have beam correspondence, without beam sweeping, between the transmit beam and receive beam. For example, if the transmit beam to a second UE is known, the receive beam from the second UE is also known without beam sweeping. In one example of this disclosure, a UE can have beam correspondence, without beam sweeping, between the transmit beam and receive beam. For example, if the receive beam from a second UE is known, the transmit beam to the second UE is also known without beam sweeping. In one example, a UE performs beam sweeping to determine a receive beam from a second UE, regardless of whether or not it knows a transmit beam to the second UE. In one example, a UE performs beam sweeping to determine a transmit beam to a second UE, regardless of whether or not it knows a receive beam from the second UE.

In one example, with reference to FIG. 8, a first UE (e.g., UE-A) is transmitting PSSCH/PSCCH to a second UE (e.g., UE-B). UE-B replies with a PSFCH to UE-A. In one example, UE-A uses a transmit beam (or spatial domain transmission filter), T_{A1}, for PSSCH/PSCCH, and UE-B uses a receive beam (or spatial domain reception filter), R_{B1}, for PSSCH/PSCCH. A beam-pair (T_{A1}-R_{B1}) is initially acquired and maintained between UE-A and UE-B for PSSCH/PSCCH. In one example, UE-B uses a transmit beam (or spatial domain transmission filter), T_{B1}, for PSFCH, and UE-A uses a receive beam (or spatial domain reception filter), R_{A1}, for PSFCH. A beam-pair (T_{B1}-R_{A1}) is initially acquired and maintained between UE-A and UE-B for PSFCH.

In one example, UE-A has beam correspondence between the transmit beam, T_{A1}, for PSSCH/PSCCH and the receive beam, R_{A1}, for PSFCH, e.g., if UE-A knows or determines T_{A1}, it can determine R_{A1} without beam sweeping and vice versa.

In one example, UE-A doesn't have beam correspondence between the transmit beam, T_{A1}, for PSSCH/PSCCH and the receive beam, R_{A1}, for PSFCH, e.g., if UE-A knows or determines T_{A1}, it can perform beam sweeping to determine R_{A1} and vice versa.

In one example, UE-B has beam correspondence between the transmit beam, T_{B1}, for PSFCH and the receive beam, R_{B1}, for PSSCH/PSCCH, e.g., if UE-B knows or determines T_{B1}, it can determine R_{B1} without beam sweeping and vice versa.

In one example, UE-B doesn't have beam correspondence between the transmit beam, T_{B1}, for PSFCH and the receive beam, R_{B1}, for PSSCH/PSCCH, e.g., if UE-B knows or determines T_{B1}, it can perform beam sweeping to determine R_{B1} and vice versa.

In one example, the roles of UE-A and UE-B can be reserved, e.g., UE-B transmits PSSCH/PSCCH and receives PSFCH, and UE-A receives PSSCH/PSCCH and transmits PSFCH.

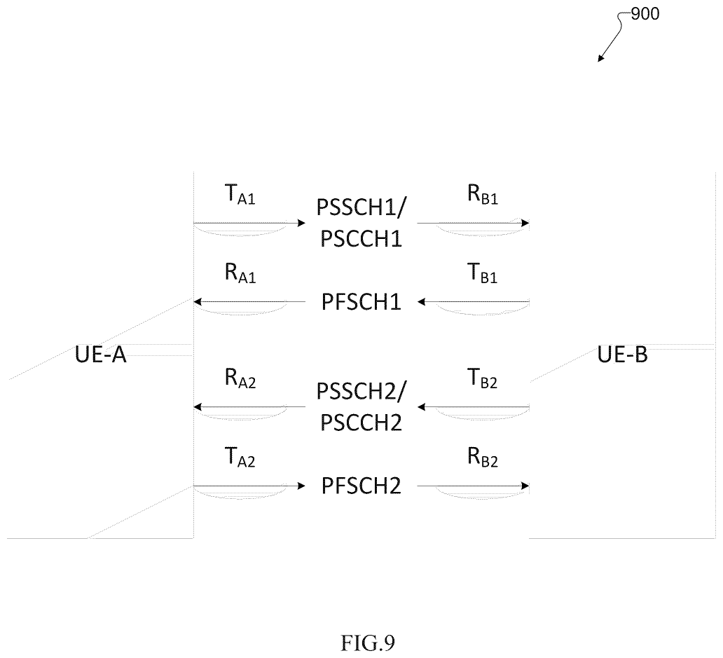

FIG. 9 illustrates a diagram of example PSSCH/PSCCH and PSFCH transmissions 900 according to embodiments of the present disclosure. For example, PSSCH/PSCCH and PSFCH transmissions 900 can be transmitted/received by any of the UEs 111-116 of FIG. 1, such as the UE 111 and UE 111B. This example is for illustration only and other embodiments can be used without departing from the scope of the present disclosure.

In one example, with reference to FIG. 9, a first UE (e.g., UE-A) is transmitting PSSCH1/PSCCH1 to a second UE (e.g., UE-B), and UE-B replies with a PSFCH1 to UE-A. UE-B is transmitting PSSCH2/PSCCH2 to UE-A and UE-A replies with a PSFCH2 to UE-B. In one example, UE-A uses a transmit beam (or spatial domain transmission filter), T_{A1}, for PSSCH1/PSCCH1, and UE-B uses a receive beam (or spatial domain reception filter), R_{B1}, for PSSCH1/PSCCH1. A beam-pair (T_{A1}-R_{B1}) is initially acquired and maintained between UE-A and UE-B for PSSCH1/PSCCH1. In one example, UE-B uses a transmit beam (or spatial domain transmission filter), T_{B2}, for PSSCH2/PSCCH2, and UE-A uses a receive beam (or spatial domain reception filter), R_{A2}, for PSSCH2/PSCCH2. A beam-pair (T_{B2}-R_{A2}) is initially acquired and maintained between UE-A and UE-B for PSSCH2/PSCCH2. In one example, UE-B uses a transmit beam (or spatial domain transmission filter), T_{B1}, for PSFCH1, and UE-A uses a receive beam (or spatial domain reception filter), R_{A1}, for PSFCH1. A beam-pair (T_{B1}-R_{A1}) is initially acquired and maintained between UE-A and UE-B for PSFCH1. In one example, UE-A uses a transmit beam (or spatial domain transmission filter), T_{A2}, for PSFCH2, and UE-B uses a receive beam (or spatial domain reception filter), R_{B2}, for PSFCH2. A beam-pair (T_{A2}-R_{B2}) is initially acquired and maintained between UE-A and UE-B for PSFCH2.

In one example, UE-A uses a same transmit beam T_{A1} and transmit beam T_{A2}, when transmitting PSSCH1/PSCCH1 and PSFCH2, respectively, for transmissions to UE-B.

In one example, UE-A can use different transmit beam T_{A1} and transmit beam T_{A2}, when transmitting PSSCH1/PSCCH1 and PSFCH2, respectively, for transmissions to UE-B. For example, T_{A2} can be a wider beam than T_{A1}.

In one example, UE-A uses a same receive beam R_{A2} and receive beam R_{A1}, when receiving PSSCH2/PSCCH2 and PSFCH1, respectively, for receptions from UE-B.

In one example, UE-A can use different receive beam R_{A2} and receive beam R_{A1}, when receiving PSSCH2/PSCCH2 and PSFCH1, respectively, for reception from UE-B. For example, R_{A1} can be a wider beam than R_{A2}.

In one example, UE-B uses a same transmit beam T_{B2} and transmit beam T_{B1}, when transmitting PSSCH2/PSCCH2 and PSFCH1, respectively, for transmissions to UE-A.

In one example, UE-B can use different transmit beam T_{B2} and transmit beam T_{B1} when transmitting PSSCH2/PSCCH2 and PSFCH1, respectively, for transmissions to UE-A. For example, T_{B1} can be a wider beam than T_{B2}.

In one example, UE-B uses a same receive beam R_{B1} and receive beam R_{B2}, when receiving PSSCH1/PSCCH1 and PSFCH2, respectively, for receptions from UE-A.

In one example, UE-B can use different receive beam R_{B1} and receive beam R_{B2}, when receiving PSSCH1/PSCCH1 and PSFCH2, respectively, for reception from UE-A. For example, R_{B2} can be a wider beam than R_{B1}.

In one example, UE-A has beam correspondence between the transmit beam, T_{A1}, for PSSCH1/PSCCH1 and the receive beam, R_{A2}, for PSSCH2/PSCCH2, e.g., if UE-A knows or determines T_{A1}, it can determine R_{A2} without beam sweeping and vice versa.

In one example, UE-A doesn't have beam correspondence between the transmit beam, T_{A1}, for PSSCH1/PSCCH1 and the receive beam, R_{A2}, for PSSCH2/PSCCH2, e.g., if UE-A knows or determines T_{A1}, it can perform beam sweeping to determine R_{A2} and vice versa.

In one example, UE-A has beam correspondence between the transmit beam, T_{A2}, for PSFCH2 and the receive beam, R_{A1}, for PSFCH1, e.g., if UE-A knows or determines T_{A2}, it can determine R_{A1} without beam sweeping and vice versa.

In one example, UE-A doesn't have beam correspondence between the transmit beam, T_{A2}, for PSFCH2 and the receive beam, R_{A1}, for PSFCH1, e.g., if UE-A knows or determines T_{A2}, it can perform beam sweeping to determine R_{A1} and vice versa.

In one example, UE-B has beam correspondence between the transmit beam, T_{B2}, for PSSCH2/PSCCH2 and the receive beam, R_{B1}, for PSSCH1/PSCCH1, e.g., if UE-B knows or determines T_{B2}, it can determine R_{B1} without beam sweeping and vice versa.

In one example, UE-B doesn't have beam correspondence between the transmit beam, T_{B2}, for PSSCH2/PSCCH2 and the receive beam, R_{B1}, for PSSCH1/PSCCH1, e.g., if UE-B knows or determines T_{B2}, it can perform beam sweeping to determine R_{B1} and vice versa.

In one example, UE-B has beam correspondence between the transmit beam, T_{B1}, for PSFCH1 and the receive beam, R_{B2}, for PSFCH2, e.g., if UE-B knows or determines T_{B1}, it can determine R_{B2} without beam sweeping and vice versa.

In one example, UE-B doesn't have beam correspondence between the transmit beam, T_{B1}, for PSFCH1 and the receive beam, R_{B2}, for PSFCH, e.g., if UE-B knows or determines T_{B1}, it can perform beam sweeping to determine R_{B2} and vice versa.

In one example, with reference to FIG. 8, a first UE (e.g., UE-A) is transmitting PSSCH/PSCCH to a second UE (e.g., UE-B) as shown. In another example, with reference to FIG. 9, a first UE (e.g., UE-A) is transmitting PSSCH/PSCCH to a second UE (e.g., UE-B) and UE-B is transmitting PSSCH/PSCCH to UE-A.

In one example, the UE 111 receiving PSSCH/PSCCH channel measures a metric based on the resource elements allocated to PSSCH/PSCCH and compares it a threshold. If the measured metric is less than or equal to a threshold, or if the measured metric is less than a threshold, the UE 111 declares a beam failure instance.

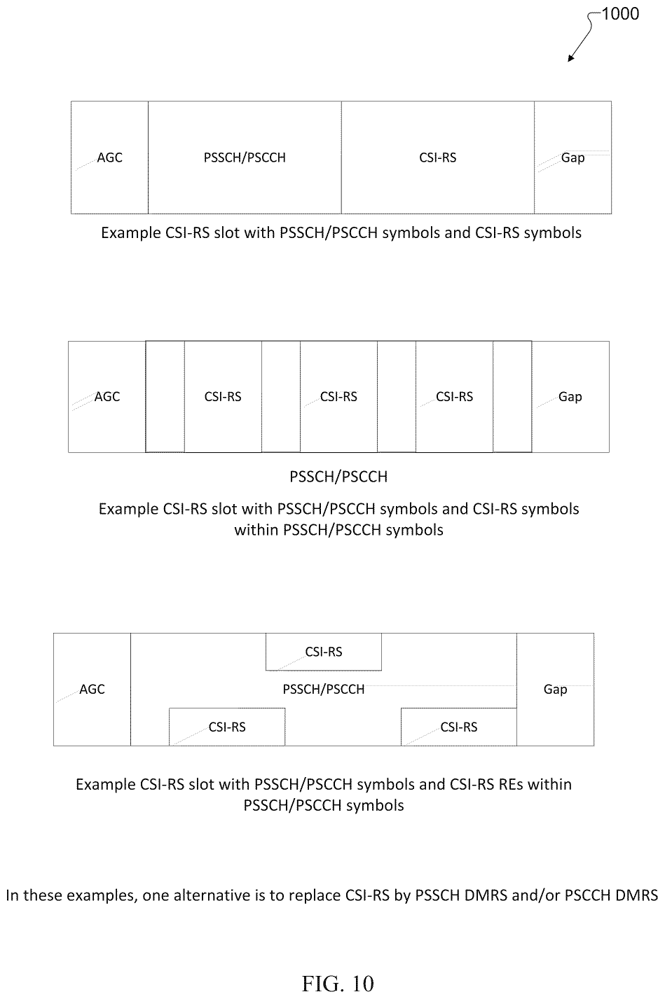

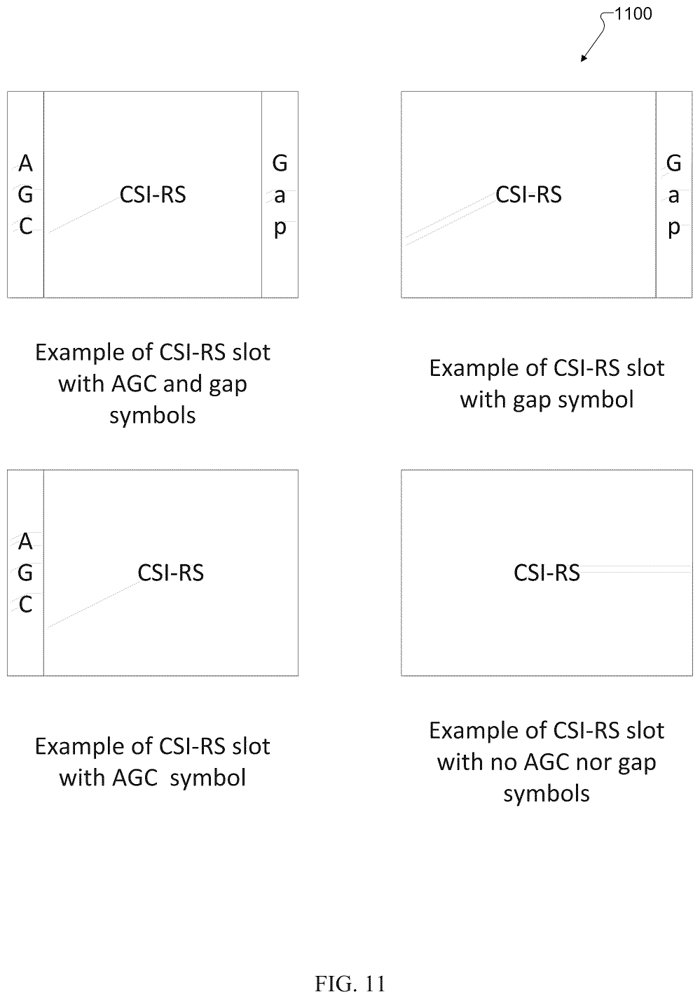

FIG. 10 illustrates diagrams of example CSI-RS slots 1000 according to embodiments of the present disclosure. For example, the UE 116 of FIG. 3 can measure CSI-RS(s) in CSI-RS slots 1000. This example is for illustration only and other embodiments can be used without departing from the scope of the present disclosure.

In one example, the UE 111 receiving PSSCH/PSCCH channel measures a metric based on the resource elements allocated to PSSCH and compares it a threshold. If the measured metric is less than or equal to a threshold, or if the measured metric is less than a threshold, the UE 111 declares a beam failure instance.

In one example, the UE 111 receiving PSSCH/PSCCH channel measures a metric based on the resource elements allocated to PSCCH and compares it a threshold. If the measured metric is less than or equal to a threshold, or if the measured metric is less than a threshold, the UE 111 declares a beam failure instance.

In one example, the UE 111 receiving PSSCH/PSCCH channel measures a metric based on the resource elements allocated to PSSCH DMRS and compares it a threshold. If the measured metric is less than or equal to a threshold, or if the measured metric is less than a threshold, the UE 111 declares a beam failure instance.

In one example, the UE 111 receiving PSSCH/PSCCH channel measures a metric based on the resource elements allocated to PSCCH DMRS and compares it a threshold. If the measured metric is less than or equal to a threshold, or if the measured metric is less than a threshold, the UE 111 declares a beam failure instance.

In one example, the UE 111 receiving PSSCH/PSCCH channel measures a metric based on the resource elements allocated to PSSCH DMRS+PSCCH DMRS and compares it a threshold. If the measured metric is less than or equal to a threshold, or if the measured metric is less than a threshold, the UE 111 declares a beam failure instance.

In one example, the UE 111 receiving PSSCH/PSCCH channel measures a metric based on the resource elements allocated to CSI-RS (e.g., CSI-RS included in or associated with the PSSCH/PSCCH transmission) and compares it a threshold. If the measured metric is less than or equal to a threshold, or if the measured metric is less than a threshold, the UE 111 declares a beam failure instance.

In one example the CSI-RS sequence is mapped to resource elements as described in TS 38.211 [REF1] clause 8.4.1.5.3 and 7.4.1.5.3.

In one example the CSI-RS resource elements in PSSCH/PSCCH can use the same beam (spatial domain filter) as the corresponding PSSCH/PSCCH.

In one example the CSI-RS resource elements in PSSCH/PSCCH can use different beams (spatial domain filters) e.g., to allow for beam sweeping.

In one example, with reference to FIG. 10, CSI-RS can be included in symbols at the end of the PSSCH/PSCCH slot. In one example, CSI-RS can be transmitted on the same beam as PSSCH/PSCCH. In one example, CSI-RS can be transmitted on different beams to allow for beam sweeping, e.g., different CSI-RS symbols can have different beam, or different groups of CSI-RS symbols can have different beams. In one example, DMRS can be use instead of CSI-RS.

In one example, with reference to FIG. 10, CSI-RS can be included in symbols distributed throughout the PSSCH/PSCCH slot. In one example, CSI-RS can be transmitted on the same beam as PSSCH/PSCCH. In one example, CSI-RS can be transmitted on different beams to allow for beam sweeping, e.g., different CSI-RS symbols can have different beam, or different groups of CSI-RS symbols can have different beams. In one example, DMRS can be use instead of CSI-RS.

In one example, with reference to FIG. 10, CSI-RS can be included in REs distributed throughout the PSSCH/PSCCH slot. In one example, CSI-RS can be transmitted on the same beam as PSSCH/PSCCH. In one example, CSI-RS can be transmitted on different beams to allow for beam sweeping, e.g., CSI-RS REs in different symbols can have different beam, or CSI-RS REs in different groups of symbols can have different beams. In one example, DMRS can be use instead of CSI-RS.

In the examples mentioned herein, a metric can be (1) reference signal received power, or (2) signal-to-noise-interference ratio (SINR).

In the examples mentioned herein, a threshold can be (pre-) configured and/or configured or updated or indicated by RRC signaling (over Uu interface and/or over PC5 interface) and/or MAC CE signaling (over Uu interface and/or over PC5 interface) and/or L1 control signaling (DCI and/or SCI (first stage SCI and/or second stage SCI) and/or PSFCH). The RRC signaling can be UE common RRC signaling (e.g., SIB signaling) or UE dedicated RRC signaling.

In the examples mentioned herein, a beam failure instance can do one or more of the following.

In one example, a beam failure instance can be provided from the PHY layer to the MAC layer.

In one example, a beam failure instance can start a beam failure detection timer.

In one example, a beam failure instance can increment a beam failure counter by 1.

In one example, if a beam failure instance is not received/declared before the beam failure timer expires, the beam failure counter is reset 0.

In one example, if a beam failure counter reaches is maximum pre-configured value or configured value, beam failure recovery is triggered, or a subsequent step of beam failure detection is triggered.

In one example, a beam failure instance can trigger beam failure recovery or a subsequent step of beam failure detection.

In one example, a next step of a beam failure recovery or a next step of beam failure detection can be one or more of the following.

In one example, a next step of a beam failure recovery or a next step of beam failure detection can be to transmit a message or signal or trigger to the UE 111 transmitting the PSSCH/PSCCH or to the UE 111 transmitting the corresponding PSFCH to transmit a periodic reference signal or channel, for example a periodic CSI-RS or periodic PSCCH/PSSCH or periodic PSCCH DMRS and/or periodic PSSCH DMRS or periodic PSFCH. In one example, the periodic reference signal or channel is transmitted on the same beam the PSSCH/PSCCH or PSFCH, respectively, is transmitted on. In one example, after transmission of the periodic reference signal or channel, the UE receiving the PSSCH/PSCCH or the UE receiving the PSFCH, respectively, can further measure the RSRP or the SINR of the periodic reference signal or channel as further described in this disclosure.

In one example, the container of the message or signal or trigger to the UE transmitting the PSSCH/PSCCH or to the UE transmitting the PSFCH to transmit a periodic reference signal or channel is one or more of: (1) an RRC signal, (2) MAC CE signaling, (3) first stage SCI, (4) second stage SCI and/or (5) PSFCH channel.

In one example, the UE receiving the PSSCH/PSCCH triggers itself to transmit a periodic reference signal or channel. In a further example, the UE receiving the PSSCH/PSCCH informs the UE transmitting the PSSCH/PSCCH of the periodic reference signal or channel.

In one example, a next step of a beam failure recovery or a next step of beam failure detection can be to transmit a message or signal or trigger to the UE transmitting the PSSCH/PSCCH or to the UE transmitting the corresponding PSFCH to transmit a periodic reference signal or channel, e.g., a periodic CSI-RS or periodic PSCCH/PSSCH or periodic PSCCH DMRS and/or periodic PSSCH DMRS or periodic PSFCH. In one example, the periodic reference signal or channel is transmitted on multiple beams for transmit beam sweeping. The transmitted periodic signal or channel can have repetition off, wherein the transmitted periodic signal or channel is transmitted on different Tx beam. The transmitted periodic signal or channel can have repetition on, wherein the transmitted periodic signal or channel is transmitted on the same Tx beam. In one example, after transmission of the periodic reference signal or channel, the UE receiving the PSSCH/PSCCH or the UE receiving the PSFCH can further measure the RSRP or the SINR of the periodic reference signal or channel and identify a new beam pair for sub-sequent communication as further described in this disclosure.

In one example, the container of the message or signal or trigger to the UE transmitting the PSSCH/PSCCH or the UE transmitting the PSFCH to transmit a periodic reference signal or channel is one or more of: (1) an RRC signal, (2) MAC CE signaling, (3) first stage SCI, (4) second stage SCI and/or (5) PSFCH channel.

In one example, the UE receiving the PSSCH/PSCCH triggers itself to transmit a periodic reference signal or channel. In a further example, the UE receiving the PSSCH/PSCCH informs the UE transmitting the PSSCH/PSCCH of the periodic reference signal or channel.

In one example, a next step of a beam failure recovery or a next step of beam failure detection can be to transmit a message or signal or trigger to the UE transmitting the PSSCH/PSCCH or to the UE transmitting the PSFCH informing of a new beam pair. In one example, the message can also indicate a metric for the new beam pair, e.g., the metric can be RSRP or SINR. In one example, the container of the message or signal to the UE transmitting the CSI-RS or to the UE transmitting the PSSCH/PSCCH or to the UE transmitting the PSFCH is one or more of: (1) an RRC signal, (2) MAC CE signaling, (3) first stage SCI, (4) second stage SCI and/or (5) PSFCH channel.

In one example, a second UE (e.g., UE-B) is transmitting PSFCH to a first UE (e.g., UE-A) as shown in FIG. 8. In another example, a first UE (e.g., UE-A) is transmitting PSFCH to a second UE (e.g., UE-B) and UE-B is transmitting PSFCH to UE-A as illustrated in FIG. 9.

In one example, the UE receiving PSFCH channel measures a metric for PSFCH and compares it a threshold. If the measured metric is less than or equal to a threshold, or if the measured metric is less than a threshold, the UE declares a beam failure instance. In a variant example, (1) (if the measured metric is less than or equal to a threshold, or if the measured metric is less than a threshold), and (2) (the measured metric is greater than zero), the UE declares a beam failure instance. In a variant example, (1) (if the measured metric is less than or equal to a first threshold, or if the measured metric is less than a first threshold), and (2) (the measured metric is greater than a second threshold or the measured metric is greater than or equal to a second threshold), the UE declares a beam failure instance.

Herein, a metric can be (1) reference signal received power, or (2) signal-to-noise-interference ratio (SINR).

Herein, a threshold (or the first threshold or the second threshold) can be (pre-) configured and/or configured or updated or indicated by RRC signaling (over Uu interface and/or over PC5 interface) and/or MAC CE signaling (over Uu interface and/or over PC5 interface) and/or L1 control signaling (DCI and/or SCI (first stage SCI and/or second stage SCI) and/or PSFCH). The RRC signaling can be UE common RRC signaling (e.g., SIB signaling) or UE dedicated RRC signaling.

In one example, the UE receiving PSFCH channel and determines if there is a DTX for PSFCH (e.g., UE determines if there is no PSFCH transmitted from the other UE). If the UE determines a PSFCH DTX (e.g., no PSFCH), the UE declares a beam failure instance.

In one example, the UE receiving PSFCH channel and determines if the HARQ-ACK contains a negative acknowledgement (NACK). If the UE determines a NACK, the UE declares a beam failure instance.

In the example mentioned herein, a beam failure instance can do one or more of the following.

In one example, a beam failure instance can be provided from the PHY layer to the MAC layer.

In one example, a beam failure instance can start a beam failure detection timer.

In one example, a beam failure instance can increment a beam failure counter by 1.

In one example, if a beam failure instance is not received/declared before the beam failure timer expires, the beam failure counter is reset 0.

In one example, if a beam failure counter reaches is maximum pre-configured value or configured value, beam failure recovery is triggered, or a subsequent step of beam failure detection is triggered.

In one example, a beam failure instance can trigger beam failure recovery or a subsequent step of beam failure detection.

In one example, a next step of a beam failure recovery or a next step of beam failure detection can be one or more of the following.

In one example, a next step of a beam failure recovery or a next step of beam failure detection can be to transmit a message or signal or trigger to the UE transmitting the PSSCH/PSCCH or to the UE transmitting the corresponding PSFCH to transmit a periodic reference signal or channel, e.g., a periodic CSI-RS or periodic PSCCH/PSSCH or periodic PSCCH DMRS and/or periodic PSSCH DMRS or periodic PSFCH. In one example, the periodic reference signal or channel is transmitted on the same beam the PSSCH/PSCCH or PSFCH, respectively, is transmitted on. In one example, after transmission of the periodic reference signal or channel, the UE receiving the PSSCH/PSCCH or the UE receiving the PSFCH, respectively, can further measure the RSRP or the SINR of the periodic reference signal or channel as further described in this disclosure.

In one example, the container of the message or signal or trigger to the UE transmitting the PSSCH/PSCCH or the UE transmitting the PSFCH to transmit a periodic reference signal or channel is one or more of: (1) an RRC signal, (2) MAC CE signaling, (3) first stage SCI, (4) second stage SCI and/or (5) PSFCH channel.

In one example, the UE receiving the PSFCH triggers itself to transmit a periodic reference signal or channel. In a further example, the UE receiving the PSFCH informs the UE transmitting the PSFCH of the periodic reference signal or channel.

In one example, a next step of a beam failure recovery or a next step of beam failure detection can be to transmit a message or signal or trigger to the UE transmitting the PSSCH/PSCCH or to the UE transmitting the corresponding PSFCH to transmit a periodic reference signal or channel, e.g., a periodic CSI-RS or periodic PSCCH/PSSCH or periodic PSCCH DMRS and/or periodic PSSCH DMRS or periodic PSFCH. In one example, the periodic reference signal or channel is transmitted on multiple beams for transmit beam sweeping. The transmitted periodic signal or channel can have repetition off, wherein the transmitted periodic signal or channel is transmitted on different Tx beam. The transmitted periodic signal or channel can have repetition on, wherein the transmitted periodic signal or channel is transmitted on the same Tx beam. In one example, after transmission of the periodic reference signal or channel, the UE receiving the PSSCH/PSCCH or the UE receiving the PSFCH can further measure the RSRP or the SINR of the periodic reference signal or channel and identify a new beam pair for sub-sequent communication as further described in this disclosure.

In one example, the container of the message or signal or trigger to the UE transmitting the PSSCH/PSCCH or the UE transmitting the PSFCH to transmit a periodic reference signal or channel is one or more of: (1) an RRC signal, (2) MAC CE signaling, (3) first stage SCI, (4) second stage SCI and/or (5) PSFCH channel.

In one example, the UE receiving the PSFCH triggers itself to transmit a periodic reference signal or channel. In a further example, the UE receiving the PSFCH informs the UE transmitting the PSFCH of the periodic reference signal or channel.

In one example, a next step of a beam failure recovery or a next step of beam failure detection can be to transmit a message or signal or trigger to the UE transmitting the PSSCH/PSCCH or to the UE transmitting the PSFCH informing of a new beam pair. In one example, the message can also indicate a metric for the new beam pair, e.g., the metric can be RSRP or SINR. In one example, the container of the message or signal to the UE transmitting the CSI-RS or to the UE transmitting the PSSCH/PSCCH or to the UE transmitting the PSFCH is one or more of: (1) an RRC signal, (2) MAC CE signaling, (3) first stage SCI, (4) second stage SCI and/or (5) PSFCH channel.

In one example, a UE is transmitting CSI-RS periodically. In one example, the CSI-RS is transmitted using a same beam or spatial domain filter as that used for a PSSCH/PSCCH channel and/or PSFCH channel transmitted from the UE. In one example, the CSI-RS is transmitted using a beam or spatial domain filter corresponding to a beam or spatial filter that is used for a PSSCH/PSCCH channel and/or PSFCH channel received by the UE. In one example, the CSI-RS is a periodic CSI-RS that is per-configured or configured by RRC signaling (over Uu interface and/or over PC5 interface). In one example, the CSI-RS is semi-persistent CSI-RS, the semi-persistent CSI-RS can be activated by MAC CE signaling (over Uu interface and/or over PC5 interface) and/or by L1 control signal DCI and/or SCI (first stage SCI and/or second stage SCI) and/or PSFCH). In one example, CSI-RS can be replaced by PSSCH DMRS and/or PSCCH DMRS.

In one example, the CSI-RS transmitted using a same beam or spatial domain filter as that used for a PSSCH/PSCCH channel and/or PSFCH channel transmitted from the UE can be pre-configured or configured.

In one example, the CSI-RS transmitted using a same beam or spatial domain filter as that used for a PSSCH/PSCCH channel and/or PSFCH channel transmitted from the UE can be indicated or signaled or triggered to be transmitted. For example, the UE receiving the PSSCH/PSCCH channel and/or PSFCH channel can transmit the indication or signal or trigger if it detects an event as mentioned herein, e.g., a beam failure event or low received signal or SINR event.

In one example, associated with the periodic reference signal or channel is a periodicity P and offset O. In one example the slot number in which the periodic CSI-RS is transmitted in is s. In one example, (s+O) % P=0.

In one example, s % P=0.

In one example, the periodicity and/or offset can be (pre-) configured and/or configured or updated or indicated by RRC signaling (over Uu interface and/or over PC5 interface) and/or MAC CE signaling (over Uu interface and/or over PC5 interface) and/or L1 control signaling (DCI and/or SCI (first stage SCI and/or second stage SCI) and/or PSFCH). The RRC signaling can be UE common RRC signaling (e.g., SIB signaling) or UE dedicated RRC signaling. In one example, the periodicity and/or offset is signaled in the message or signal or trigger to the UE transmitting the PSSCH/PSCCH to transmit a periodic reference signal.

In one example, the periodicity and/or offset can be in physical slots or in logical slots that can be in a resource pool or in logical slots in a resource pool.

FIG. 11 illustrates diagrams of example CSI-RS slots 1100 according to embodiments of the present disclosure. For example, the UE 111C of FIG. 1 can measure CSI-RS(s) in CSI-RS slots 1100. This example is for illustration only and other embodiments can be used without departing from the scope of the present disclosure.

In one example, periodic CSI-RS slot structure can be such that it only includes CSI-RS. In some examples, there can be an AGC (e.g., duplicate) symbol at the start of the CSI-RS slot. With reference to FIG. 11, in some examples, there can be a gap symbol at the end of the CSI-RS slot as shown. In one example, CSI-RS can be replaced by PSSCH DMRS and/or PSCCH DMRS.

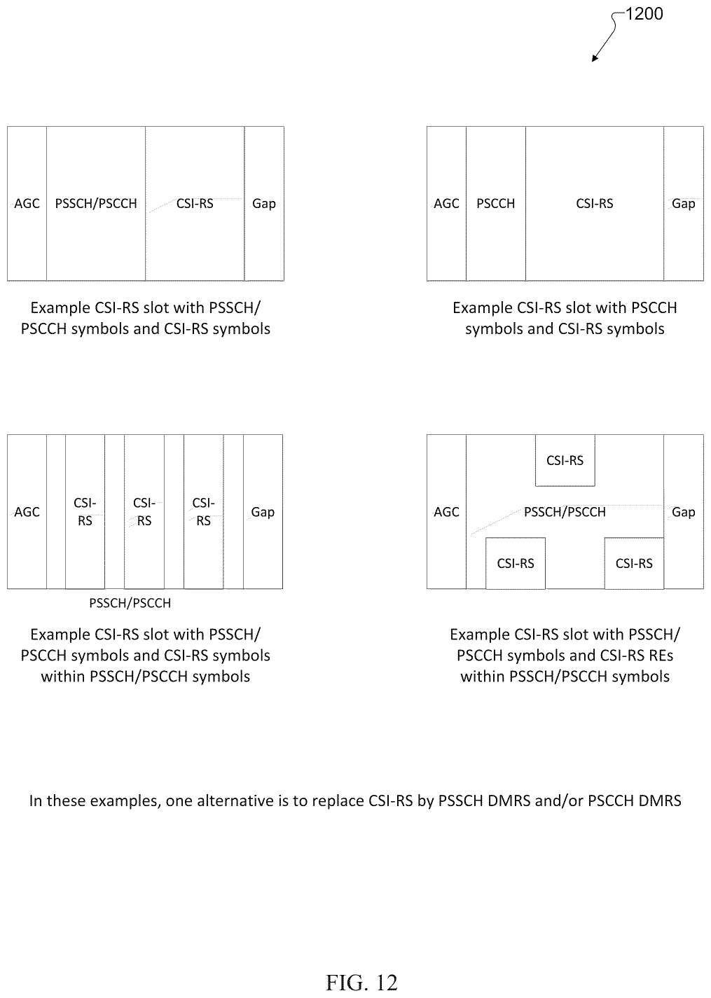

FIG. 12 illustrates diagrams of example CSI-RS slots 1200 according to embodiments of the present disclosure. For example, CSI-RS slots 1200 can be received by the UE 116 of FIG. 3. This example is for illustration only and other embodiments can be used without departing from the scope of the present disclosure.

In one example, periodic CSI-RS slot structure can be such that it includes CSI-RS+PSSCH/PSCCH or CSI-RS+PSCCH. In some examples, PSSCH can include only 2nd stage SCI. In some example, PSSCH can include 2nd stage SCI+SL-SCH.

With reference to FIG. 12, in one example, CSI-RS can be replaced by PSSCH DMRS and/or PSCCH DMRS.

In one example, periodic or semi-persistent CSI-RS is transmitted in a dedicated resource pool. In one example periodic or semi-persistent CSI-RS is transmitted in a resource pool shared with SL communications or SL data.

In one example, the UE receiving the CSI-RS measures a metric for CSI-RS and compares it a threshold. If the measured metric is less than or equal to a threshold, or if the measured metric is less than a threshold, the UE declares a beam failure instance.

Herein, a metric can be (1) reference signal received power, or (2) signal-to-noise-interference ratio (SINR).

Herein, a threshold can be (pre-) configured and/or configured or updated or indicated by RRC signaling (over Uu interface and/or over PC5 interface) and/or MAC CE signaling (over Uu interface and/or over PC5 interface) and/or L1 control signaling (DCI and/or SCI (first stage SCI and/or second stage SCI) and/or PSFCH). The RRC signaling can be UE common RRC signaling (e.g., SIB signaling) or UE dedicated RRC signaling.

In the example mentioned herein, a beam failure instance can do one or more of the following.

In one example, a beam failure instance can be provided from the PHY layer to the MAC layer.

In one example, a beam failure instance can start a beam failure detection timer.

In one example, a beam failure instance can increment a beam failure counter by 1.

In one example, if a beam failure instance is not received/declared before the beam failure timer expires, the beam failure counter is reset 0.

In one example, if a beam failure counter reaches is maximum pre-configured value or configured value, beam failure recovery is triggered, or a subsequent step of beam failure detection is triggered.

In one example, a beam failure instance can trigger beam failure recovery or a subsequent step of beam failure detection.

In one example, a next step of a beam failure recovery or a next step of beam failure detection can be one or more of the following.

In one example, a next step of a beam failure recovery or a next step of beam failure detection can be to transmit a message or signal or trigger to the UE transmitting the CSI-RS to transmit a periodic reference signal or channel using more than one beam or a beam different from that used for the CSI-RS, e.g., a periodic CSI-RS or periodic PSCCH/PSSCH or periodic PSCCH DMRS and/or periodic PSSCH DMRS or periodic PSFCH. In one example, the periodic reference signal or channel is transmitted on multiple beams for transmit beam sweeping. The transmitted periodic signal or channel can have repetition off, wherein the transmitted periodic signal or channel is transmitted on different Tx beam. The transmitted periodic signal or channel can have repetition on, wherein the transmitted periodic signal or channel is transmitted on the same Tx beam. In one example, after transmission of the periodic reference signal or channel, the UE receiving the PSSCH/PSCCH can further measure the RSRP or the SINR of the periodic reference signal or channel and identify a new beam pair for sub-sequent communication as further described in this disclosure.

In one example, the container of the message or signal or trigger to the UE transmitting the CSI-RS to transmit a periodic reference signal or channel is one or more of: (1) an RRC signal, (2) MAC CE signaling, (3) first stage SCI, (4) second stage SCI and/or (5) PSFCH channel.

In one example, a next step of a beam failure recovery or a next step of beam failure detection can be to transmit a message or signal or trigger to the UE transmitting the CSI-RS informing of a new beam pair. In one example, the message can also indicate a metric for the new beam pair, e.g., the metric can be RSRP or SINR. In one example, the container of the message or signal to the UE transmitting the CSI-RS is one or more of: (1) an RRC signal, (2) MAC CE signaling, (3) first stage SCI, (4) second stage SCI and/or (5) PSFCH channel.

In one example, a UE is transmitting CSI-RS periodically. In one example, the CSI-RS is transmitted using a beam or spatial domain filter as that is different from the beam or spatial domain filter used for a PSSCH/PSCCH channel and/or PSFCH channel transmitted from the UE. For example, this can be for identifying a new beam. In one example, the CSI-RS is transmitted using a beam or spatial domain filter not corresponding to a beam or spatial filter that is used for a PSSCH/PSCCH channel and/or PSFCH channel received by the UE. For example, this can be for identifying a new beam. In one example, the CSI-RS is transmitted using multiple beams or spatial domain filters, for example this can be to allow for beam sweeping, e.g., for identifying new beam.

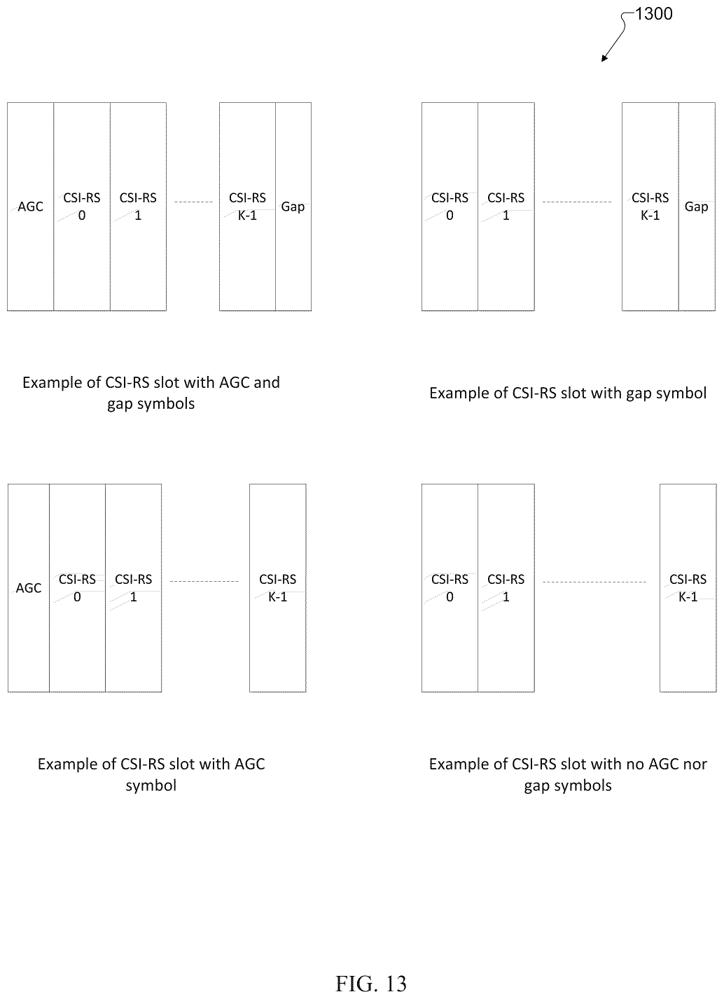

FIG. 13 illustrates diagrams of example CSI-RS slots 1300 according to embodiments of the present disclosure. For example, the UE 111B of FIG. 1 can measure CSI-RS(s) in CSI-RS slots 1300. This example is for illustration only and other embodiments can be used without departing from the scope of the present disclosure.

In one example, the transmitted periodic signal or channel can have repetition off, wherein the transmitted periodic signal or channel can be transmitted on different Tx beam for consecutive transmission instances. For example, there can be multiple instances of the periodic signal or channel within a slot and each instance is transmitted on a different beam. In another example, there can be multiple instances of periodic signal or channel across slots and each instance is transmitted on a different beam.

In one example, the transmitted periodic signal or channel can have repetition on, wherein the transmitted periodic signal or channel is transmitted on the same Tx beam across multiple instances. This can allow for receiver beam sweeping across a same Tx beam. In one example, there are multiple transmit instances for the periodic signal or channels in a slot, and all use a same beam or spatial domain transmission filter. In one example, there are multiple transmit instances for the periodic signal or channel in a slot. N instances use a first beam or spatial domain transmission filter, the next N instances use a second beam or spatial domain transmission filter, and so on. In one example, different beams can be used in different slots. In one example, the beam or beams is repeated in M slots. In one example, there are K instances of periodic signals or channels in a slot. The instances are number sequentially across slots e.g., slots used for the transmission of the periodic signals or channels, for example starting at instance 0 in the first slot at or after slot 0 of frame with an SFN (e.g., SFN 0), or slot 0 of frame with a DFN (e.g., DFN 0). The first N instances use a first beam or spatial domain filter, the next N instances use a second beam or spatial domain filter, and so on. Wherein, N and/or M and K can be (pre-) configured and/or configured or updated or indicated by RRC signaling (over Uu interface and/or over PC5 interface) and/or MAC CE signaling (over Uu interface and/or over PC5 interface) and/or L1 control signaling (DCI and/or SCI (first stage SCI and/or second stage SCI) and/or PSFCH). The RRC signaling can be UE common RRC signaling (e.g., SIB signaling) or UE dedicated RRC signaling.

In one example, the CSI-RS is a periodic CSI-RS that is per-configured or configured by RRC signaling (over Uu interface and/or over PC5 interface). In one example, the CSI-RS is semi-persistent CSI-RS. The semi-persistent CSI-RS can be activated by MAC CE signaling (over Uu interface and/or over PC5 interface) and/or by L1 control signal DCI and/or SCI (first stage SCI and/or second stage SCI) and/or PSFCH). In one example, CSI-RS can be replaced by PSSCH DMRS and/or PSCCH DMRS.

In one example, the CSI-RS transmitted using (1) a different same beam or different spatial domain filter than that used for a PSSCH/PSCCH channel and/or PSFCH channel transmitted from the UE and/or (2) multiple beams or multiple spatial domain filters can be pre-configured or configured.

In one example, the CSI-RS transmitted using (1) a different beam or different spatial domain filter than that used for a PSSCH/PSCCH channel and/or PSFCH channel transmitted from the UE and/or (2) multiple beams or multiple spatial domain filters can be indicated or signaled or triggered to be transmitted. For example, the UE receiving the PSSCH/PSCCH channel and/or PSFCH channel and/or CSI-RS can transmit the indication or signal or trigger if it detects an event as mentioned herein, e.g., a beam failure event or low received signal or SINR event.

In one example, associated with the periodic reference signal or channel is a periodicity P and offset O. In one example the slot number in which the periodic CSI-RS is transmitted in is s. In one example, (s+0)% P=0.

In one example, s % P=0.

In one example, the periodicity and/or offset can be (pre-) configured and/or configured or updated or indicated by RRC signaling (over Uu interface and/or over PC5 interface) and/or MAC CE signaling (over Uu interface and/or over PC5 interface) and/or L1 control signaling (DCI and/or SCI (first stage SCI and/or second stage SCI) and/or PSFCH). The RRC signaling can be UE common RRC signaling (e.g., SIB signaling) or UE dedicated RRC signaling. In one example, the periodicity and/or offset is signaled in the message or signal or trigger to the UE transmitting the PSSCH/PSCCH to transmit a periodic reference signal.

In one example, the periodicity and/or offset can be in physical slots or in logical slots that can be in a resource pool or in logical slots in a resource pool.

With reference to FIG. 11, in one example, periodic CSI-RS slot structure can be such that it only includes CSI-RS. In one example, there can be one instance of CSI-RS as shown. With reference to FIG. 13, there can be multiple instances of CSI-RS (e.g., K) as shown. In one example, CSI-RS can be replaced by PSSCH DMRS and/or PSCCH DMRS.

In one example, with reference to FIG. 12, periodic CSI-RS slot structure can be such that it includes one of the following: (1) one instance of CSI-RS+ one instance of PSSCH/PSCCH or one instance of CSI-RS+ one instance PSCCH, or (2) K instances of CSI-RS+ one instance of PSSCH/PSCCH or K instances of CSI-RS+ one instance PSCCH, or (3) K instances of CSI-RS+K instances of PSSCH/PSCCH or K instances of CSI-RS+K instances of PSCCH. In some examples, PSSCH can include only 2^{nd} stage SCI. In some example, PSSCH can include 2^{nd} stage SCI+SL-SCH. In one example, CSI-RS can be replaced by PSSCH DMRS and/or PSCCH DMRS.

In one example, periodic or semi-persistent CSI-RS is transmitted in a dedicated resource pool. In one example periodic or semi-persistent CSI-RS is transmitted in a resource pool shared with SL communications or SL data.

In one example, the UE receiving the CSI-RS measures a metric for CSI-RS and compares it a threshold. If the measured metric is greater than or equal to a threshold, or if the measured metric is greater than a threshold, the UE can identify a new beam or spatial domain transmission filter, the beam or spatial domain transmission filter can be based on the instance on which the CSI-RS is being measured.

Herein, a metric can be (1) reference signal received power, or (2) signal-to-noise-interference ratio (SINR) or (1) reference signal received power relative to that of the beam used for PSSCH/PSCCH or PSFCH, or (2) signal-to-noise-interference ratio (SINR) relative to that of the beam used for PSSCH/PSCCH or PSFCH.

Herein, a threshold can be (pre-) configured and/or configured or updated or indicated by RRC signaling (over Uu interface and/or over PC5 interface) and/or MAC CE signaling (over Uu interface and/or over PC5 interface) and/or L1 control signaling (DCI and/or SCI (first stage SCI and/or second stage SCI) and/or PSFCH). The RRC signaling can be UE common RRC signaling (e.g., SIB signaling) or UE dedicated RRC signaling.

In the example mentioned herein, a beam failure instance can do one or more of the following.

In one example, a new beam can be provided from the PHY layer to the MAC layer.

In one example, a next step of a beam failure recovery or a next step of beam failure detection can be to transmit a message or signal or trigger to the UE transmitting the CSI-RS informing of a new beam pair. In one example, the message can also indicate a metric for the new beam pair, e.g., the metric can be RSRP or SINR. In one example, the container of the message or signal to the UE transmitting the CSI-RS is one or more of: (1) an RRC signal, (2) MAC CE signaling, (3) first stage SCI, (4) second stage SCI and/or (5) PSFCH channel.

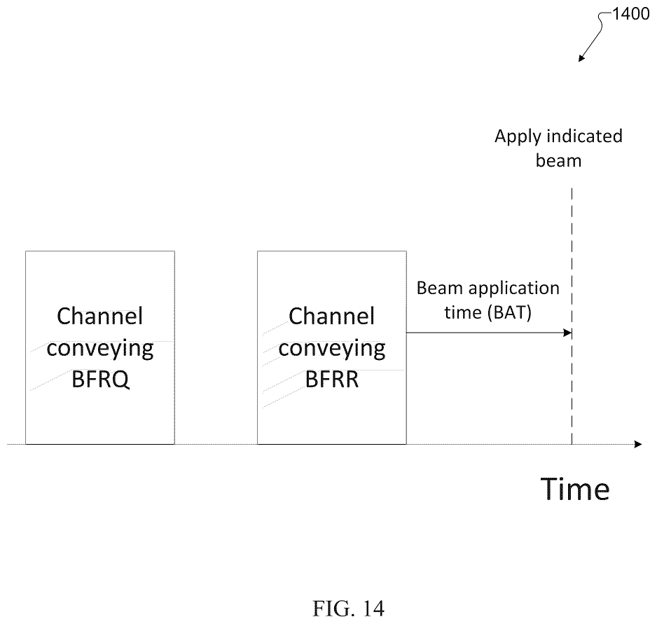

FIG. 14 illustrates a timeline 1400 for applying an indicated beam according to embodiments of the present disclosure. For example, timeline 1400 for applying an indicated beam can be followed by the UE 111C of FIG. 1. This example is for illustration only and other embodiments can be used without departing from the scope of the present disclosure.

In one example, a first UE (e.g., UE-A) receives a new beam indication from a second UE (e.g., UE-B). For example, the new beam indication can be part of a beam failure recovery procedure, e.g., the new beam indication can be a beam failure recovery request (BFRQ). In one example, the transmission of a periodic channel or signal (e.g., CSI-RS, or second PSCCH/PSSCH or second PSCCH DMRS and/or second PSSCH DMRS or second PSFCH) for beam identification from UE-A can stop after BFRQ.

In one example, UE-A transmits a beam failure recovery response (BFRR) to UE-B.

In one example, UE-A transmits a beam failure recovery response (BFRR) to UE-B using a new beam that is indicated in the BFRQ.

In one example, UE-A transmits a beam failure recovery response (BFRR) to UE-B using the original beam.

In one example, the BFRQ includes one beam.

In one example, the BFRQ includes multiple new beams, and the UE receiving the BFRQ selects or determines one of these beams and indicates it in the BFRR to UE-B.

In one example, the BFRQ includes multiple new beams, and the UE receiving the BFRQ selects or determines one of these beams and indicates it in the BFRR to UE-B, and the BFRR is transmitted using the determined or selected new beam.

In one example, the BFRQ includes multiple new beams, and the UE receiving the BFRQ selects or determines one of these beams and indicates it in the BFRR to UE-B using the original beam.

In one example, UE-B receives the BFRR, and the new applies the new beam (e.g., as indicated in the BFRR or as indicated in the BFRQ) after a delay T.

In one example, the delay T is from the start of the channel or signal conveying the BFRQ.

In one example, the delay T is from the end of the channel or signal conveying the BFRQ.

In one example, the delay T is from the start of the channel or signal conveying the BFRR.

In one example, with reference to FIG. 14, the delay T is from the end of the channel or signal conveying the BFRR.

In one example, UE-A new applies the new beam (e.g., as indicated in the BFRR or as indicated in the BFRQ) after a delay T.

In one example, the delay T is from the start of the channel or signal conveying the BFRQ.

In one example, the delay T is from the end of the channel or signal conveying the BFRQ.

In one example, the delay T is from the start of the channel or signal conveying the BFRR.

In one example, the delay T is from the end of the channel or signal conveying the BFRR.

In one example, UE-A applies the new beam starting from the channel conveying the BFRR.

In one example, the channel conveying the BFRR can be: PSSCH carrying RRC message with BFRR and/or PSSCH carrying MAC CE with BFRR and/or PSSCH carrying MAC CE with BFRR along with second stage SCI with BFRR and/or PSSCH with second stage SCI with BFRR and/or PSCCH with first stage SCI with BFRR and/or PSFCH with BFRR.

The terms BFRQ and BFRR are generically used for any message that indicates a new beam (or multiple new beams) for beam failure recovery, and the corresponding response message, respectively. The BFRR can be considered as an acknowledgment of the BFRQ (e.g., indication of a new beam).

In the aforementioned examples, T can be (pre-) configured and/or configured or updated or indicated by RRC signaling (over Uu interface and/or over PC5 interface) and/or MAC CE signaling (over Uu interface and/or over PC5 interface) and/or L1 control signaling (DCI and/or SCI (first stage SCI and/or second stage SCI) and/or PSFCH). The RRC signaling can be UE common RRC signaling (e.g., SIB signaling) or UE dedicated RRC signaling. In the aforementioned examples, T can be indicated in the BFRQ or the BFRR.

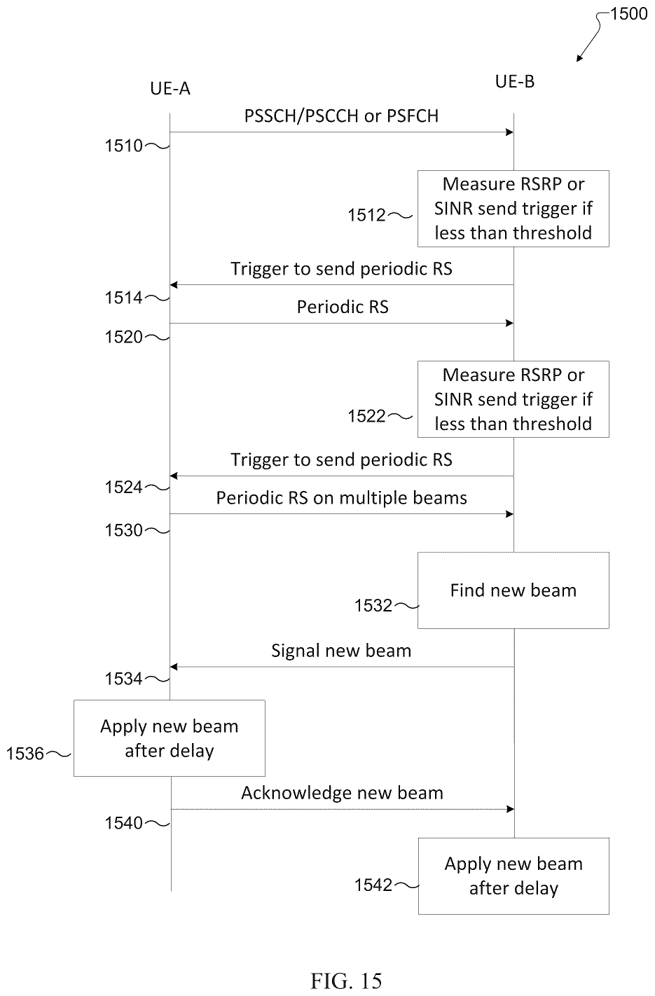

FIG. 15 illustrates a flowchart of an example UE procedure 1500 for beam failure detection and beam failure recovery. For example, procedure 1500 for beam failure detection and beam failure recovery can be performed by the UE 111 and UE 111A of FIG. 1. This example is for illustration only and other embodiments can be used without departing from the scope of the present disclosure.

The procedure begins in 1510, a first UE (e.g., UE-A) is transmitting a SL channel, e.g., PSSCH/PSCCH and/or PSFCH to a second UE (e.g., UE-B). In 1512, UE-B can measure a metric of the SL channel, e.g., RSRP or SINR. In 1514, if the metric is below a threshold, UE-B can transmit a trigger to UE-A to transmit a periodic or semi-persistent channel or signal (e.g., CSI-RS, or second PSCCH/PSSCH or second PSCCH DMRS and/or second PSSCH DMRS or second PSFCH) using the same beam as PSSCH/PSCCH or PSFCH or using a different beam than PSSCH/PSCCH or PSFCH or using multiple beams, e.g., for beam sweeping.

In 1520, UE-A transmits a periodic or semi-persistent channel or signal (e.g., CSI-RS) using a same beam as that used for PSSCH/PSCCH or PSFCH. In one example, the transmission of the channel or signal can be triggered by UE-B, e.g., as described in 1510. In another example, the transmission of the channel or signal can be by pre-configuration or configuration. In 1522, UE-B can measure a metric of the signal or channel, e.g., RSRP or SINR. In 1524, if the metric is below a threshold, UE-B can transmit a trigger to UE-A to transmit a periodic or semi-persistent channel or signal (e.g., CSI-RS or second PSCCH/PSSCH or second PSCCH DMRS and/or second PSSCH DMRS or second PSFCH) using a different beam than PSSCH/PSCCH or PSFCH or using multiple beams, e.g., for beam sweeping.

In 1530, UE-A transmits a periodic or semi-persistent channel or signal (e.g., CSI-RS or second PSCCH/PSSCH or second PSCCH DMRS and/or second PSSCH DMRS or second PSFCH) using a different beam than that used for PSSCH/PSCCH or PSFCH or using multiple beams, e.g., for beam sweeping. In one example, the transmission of the channel or signal can be triggered by UE-B, e.g., as described in 1510 or as described in 1520. In another example, the transmission of the channel or signal can be by pre-configuration or configuration. In 1532, UE-B can measure a metric of the signal or channel, e.g., RSRP or SINR, to identify a new beam. In 1534, if a new beam is identified, UE-B can transmit a message to UE-A with the new beam or beams, in one example the message can include the metric of the new beam or metrics of the new beams. In one example, the transmission of the periodic channel or signal (e.g., CSI-RS, or second PSCCH/PSSCH or second PSCCH DMRS and/or second PSSCH DMRS or second PSFCH) for beam identification from UE-A can stop after UE-A receives a message with the new beam indication. In 1536, UE-A can apply the new beam after a delay from beam indication. In a variant example, UE-A can apply the new beam after a delay from the acknowledgement of step 1540.

In 1540, UE-A when it receives a new metric or metrics, can acknowledge the message. In one example, the acknowledgement can be transmitted using the new beam, in another example, the acknowledgment can be transmitted using the old beam. In 1542, UE-B, after receiving the acknowledgement, can apply the new beam after a delay from acknowledgment. In another example, UE-B can apply the new beam after a delay from the message carrying the new beam indication.

In one example, the BFRQ is transmitted through a carrier other than the carrier on which the beam failure detection is detected. In one example, beam failure occurs on carrier C1 and the BFRQ is transmitted on carrier C2.

In one example C1 is in FR2 and C2 is in FR1.

In one example C1 is in FR2 and C2 is on FR2.

In one example C1 is in FR1 and C2 is in FR1.

In one example C1 is in FR1 and C2 is on FR2.

In one example, the BFRR is transmitted through a carrier other than the carrier on which the beam failure detection is detected. In one example, beam failure occurs on carrier C1 and the BFRR is transmitted on carrier C2.

In one example C1 is in FR2 and C2 is in FR1.

In one example C1 is in FR2 and C2 is on FR2.

In one example C1 is in FR1 and C2 is in FR1.

In one example C1 is in FR1 and C2 is on FR2.

In one example, the BFRR is transmitted through a carrier other than the carrier on which BFRQ is transmitted/received on. In one example, BFRQ is on carrier C1 and the BFRR is transmitted on carrier C2.

In one example C1 is in FR2 and C2 is in FR1.

In one example C1 is in FR2 and C2 is on FR2.

In one example C1 is in FR1 and C2 is in FR1.

In one example C1 is in FR1 and C2 is on FR2.

In one example beam failure detection can happen on UE receiving PSCCH/PSSCH or transmitting PSFCH.

In one example beam failure detection can happen on UE transmitting PSCCH/PSSCH or receiving PSFCH.

In one example, a beam failure detection signal is transmitted to network (e.g., gNB/TRP) by RRC signaling and/or MAC CE signaling and/or L1 control signaling (e.g., UCI). The beam failure detection signal is transmitted to the network 130 or gNB from the UE that detected a beam failure.

In one example, a beam failure recovery request (BFRQ) is transmitted to network (e.g., gNB/TRP) by RRC signaling and/or MAC CE signaling and/or L1 control signaling (e.g., UCI). The BFRQ is transmitted to the network 130 or gNB from the UE that detected a beam failure.

In one example, a beam failure recovery request (BFRQ) is transmitted from network (e.g., gNB/TRP) by RRC signaling and/or MAC CE signaling and/or L1 control signaling (e.g., UCI). The BFRQ is transmitted from the network 130 or gNB to the UE that is transmitting the signal/channel with a failed beam. In a further example, the BFRQ can trigger transmission of new beam identification reference signals.

In one example, a beam failure recovery request (BFRQ) is transmitted to network (e.g., gNB/TRP) by RRC signaling and/or MAC CE signaling and/or L1 control signaling (e.g., UCI). The BFRQ is transmitted to the network 130 or gNB from the UE that detected a beam failure and includes a new beam identification.

In one example, a beam failure recovery request (BFRQ) is transmitted from network (e.g., gNB/TRP) by RRC signaling and/or MAC CE signaling and/or L1 control signaling (e.g., UCI). The BFRQ is transmitted from the network 130 or gNB to the UE that is transmitting the signal/channel with a failed beam and includes a new beam identification.

In one example, a beam failure recovery response (BFRR) is transmitted to network (e.g., gNB/TRP) by RRC signaling and/or MAC CE signaling and/or L1 control signaling (e.g., UCI). The BFRR is transmitted to the network 130 or gNB from the UE that received a new beam identification.

In one example, a beam failure recovery request (BFRR) is transmitted from network (e.g., gNB/TRP) by RRC signaling and/or MAC CE signaling and/or L1 control signaling (e.g., UCI). The BFRR is transmitted from the network 130 or gNB to the UE that detected the new beam identification.

The benefit of this disclosure is that it provides design components for the SL beam management, e.g., for beam failure detection and beam failure recovery. This beneficial for the operation of SL in FR2. The benefit of operating in FR2 is to have access to large BW for applications demanding very high data rates and throughputs.

Various embodiments of the disclosure are directed to the NR or 6G standards.

Sidelink is one of the promising features of NR, targeting verticals such the automotive industry, public safety, and other commercial application. Sidelink has been first introduced to NR in release 16 and further enhanced in release 17. In release 18, one of the objectives of SL is beam management to support operation in FR2. This disclosure provides a beam management design for SL e.g., for beam failure detection and beam failure recovery.

The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the figures illustrate different examples of user equipment, various changes may be made to the figures. For example, the user equipment can include any number of each component in any suitable arrangement. In general, the figures do not limit the scope of this disclosure to any particular configuration(s). Moreover, while figures illustrate operational environments in which various user equipment features disclosed in this patent document can be used, these features can be used in any other suitable system.

Any of the above variation embodiments can be utilized independently or in combination with at least one other variation embodiment.

Although the present disclosure has been described with exemplary embodiments, various changes and modifications may be suggested to one skilled in the art. It is intended that the present disclosure encompass such changes and modifications as fall within the scope of the appended claims. None of the descriptions in this application should be read as implying that any particular element, step, or function is an essential element that must be included in the claims scope. The scope of patented subject matter is defined by the claims.

What is claimed is:

1. A user equipment (UE) comprising:
a transceiver configured to receive, from a second UE:
a first instance of a first sidelink (SL) channel, and
M SL signals for identification of new beams, where M>1; and
a processor operably coupled to the transceiver, the processor configured to:
measure a metric based on the first SL channel,
declare, based on the metric, a beam failure, and
identify, based on the declaration of the beam failure, a SL signal from the M SL signals for identification of a new beam,
wherein the transceiver is further configured to transmit a second SL channel with a first beam indication based on the SL signal.

2. The UE of claim 1, wherein:
the first SL channel is a physical sidelink shared channel (PSSCH) or a physical sidelink control channel (PSCCH), and
the metric is based on a reference signal received power (RSRP) of a PSSCH demodulation reference signal (DM-RS) or a PSCCH DM-RS.

3. The UE of claim 2, wherein:
the processor is further configured to:
set a beam failure indicator when the RSRP of the PSSCH DM-RS or the PSCCH DM-RS is less than a first threshold, and
increment a counter when the beam failure indicator is set, and
the beam failure is declared when the counter reaches a second threshold.

4. The UE of claim 1, wherein, when the beam failure is declared, the transceiver is further configured to transmit, to the second UE, a third SL channel to trigger transmission of the M SL signals.

5. The UE of claim 1, wherein the transceiver is further configured to apply, after a time T, a spatial domain reception filter, based on the SL signal, for reception of a second instance of the first SL channel.

6. The UE of claim 1, wherein the transceiver is further configured to receive, from the second UE, an acknowledgement in response to the second SL channel.

7. The UE of claim 1, wherein the transceiver is further configured to:
transmit a first instance of a third SL channel,
receive a fourth SL channel with a trigger for a transmission of N SL signals, where N>1,
transmit the N SL signals, where each SL signal of the N SL signals is transmitted using a corresponding spatial domain transmission filter, and
receive a fifth SL channel with a second beam indication based on one of the N SL signals.

8. The UE of claim 7, wherein the transceiver is further configured to apply a spatial domain transmission filter, after a time T from a time of reception of the fifth SL channel, for transmission of a second instance of the third SL channel based on the second beam indication.

9. The UE of claim 7, wherein, the transceiver is further configured to transmit an acknowledgment in response to the fifth SL channel.

10. The UE of claim 7, wherein:
the N SL signals are N SL channel state information reference signals (SL CSI-RS) in one or more slots, and
K of the N SL CSI-RS are transmitted within a slot using K spatial domain transmission filters, where K≤N.

11. A method of operating a user equipment (UE), the method comprising:
receiving, from a second UE:
a first instance of a first sidelink (SL) channel, and
M SL signals for identification of new beams, where M>1;
measuring a metric based on the first SL channel;
declaring, based on the metric, a beam failure;
identifying, based on the declaration of the beam failure, a SL signal from the M SL signals for identification of a new beam; and
transmitting a second SL channel with a first beam indication based on the SL signal.

12. The method of claim 11, wherein:
the first SL channel is a physical sidelink shared channel (PSSCH) or a physical sidelink control channel (PSCCH), and
the metric is based on a reference signal received power (RSRP) of a PSSCH demodulation reference signal (DM-RS) or a PSCCH DM-RS.

13. The method of claim 12, further comprising:
setting a beam failure indicator when the RSRP of the PSSCH DM-RS or the RSRP of the PSCCH DM-RS is less than a first threshold; and
incrementing a counter when the beam failure indicator is set,
wherein the beam failure is declared when the counter reaches a second threshold.

14. The method of claim 11, further comprising:
when the beam failure is declared, transmitting, to the second UE, a third SL channel to trigger transmission of the M SL signals.

15. The method of claim 11, further comprising:
applying, after a time T, a spatial domain reception filter, based on the SL signal, for reception of a second instance of the first SL channel.

16. The method of claim 11, further comprising:
receiving, from the second UE, an acknowledgement in response to the second SL channel.

17. The method of claim 11, further comprising:
transmitting a first instance of a third SL channel;
receiving a fourth SL channel, with a trigger for a transmission of N SL signals, where N>1;
transmitting the N SL signals, where each SL signal of the N SL signals is transmitted using a corresponding spatial domain transmission filter; and
receiving a fifth SL channel with a second beam indication based on one of the N SL signals.

18. The method of claim 17, further comprising:
applying a spatial domain transmission filter, after a time T from a time of reception of the fifth SL channel, for transmission of a second instance of the third SL channel based on the second beam indication.

19. The method of claim 17, further comprising:
transmitting an acknowledgment in response to the fifth SL channel.

20. The method of claim 17, wherein:
the N SL signals are N SL channel state information reference signals (SL CSI-RS) in one or more slots, and
K of the N SL CSI-RS are transmitted within a slot using K spatial domain transmission filters, where K≤N.
